(19) United States
(12) Patent Application Publication
(10) Pub. No.: US 2025/0043146 A1
(43) Pub. Date: Feb. 6, 2025

(54) MULTILAYER CONSTRUCTION ON METAL SUBSTRATES BASED ON POLYASPARTATE COATINGS

(71) Applicant: Covestro Deutschland AG, Leverkusen (DE)

(72) Inventors: Robert Reyer, Langenfeld (DE); Pantea Nazaran, Leverkusen (DE); Dorothea Cendlewski, Engelskirchen (DE); Thomas Baeker, Köln (DE)

(21) Appl. No.: 18/719,898

(22) PCT Filed: Dec. 14, 2022
(86) PCT No.: PCT/EP2022/085783

§ 371 Date: Jun. 14, 2024

(30) Foreign Application Priority Data
Dec. 20, 2021 (EP) 21215960.2

(51) Int. Cl. C09D 175/12

(52) U.S. Cl. CPC C09D 175/12

(57) ABSTRACT

The invention relates to a layer construction comprising at least one coating composition, which is partially or completely hardened, for a pigmented lacquer (Bp) and at least one coating composition, which is applied thereon, for a clear lacquer (BK), wherein the coating composition Bp contains at least one polyaspartic acid-containing component, at least one silane-functional polyisocyanate, and at least one pigment, and the coating composition BK likewise contains at least one polyaspartic acid-containing component and at least one polyisocyanate. The invention also relates to a layer system comprising a substrate, at least one coating composition Bp, which is applied onto at least one section of the substrate and is partly or completely cured, and at least one coating composition BK, which is applied thereon. The invention also relates to a method for producing a cured layer construction on a preferably metal substrate and to a layer system comprising a preferably metal substrate and a layer construction which can be obtained according to the aforementioned production method.

The present invention relates to a layer structure comprising at least one partially cured or fully cured coating composition for a pigmented coating (B_{P}) and at least one coating composition for a clearcoat (B_{K}) applied thereon, where coating composition B_{P} comprises at least one polyaspartic-acid-containing component, at least one silane-functional polyisocyanate, and at least one pigment, and coating composition B_{K} likewise comprises at least one polyaspartic-acid-containing component and at least one polyisocyanate.

The present invention further relates to a layer system comprising a substrate, at least one partially cured or fully cured coating composition B_{P} applied to at least part of the substrate, and at least one coating composition B_{K} applied thereon, to processes for producing a cured layer structure on a preferably metallic substrate, and to a layer system comprising a preferably metallic substrate and a layer structure obtainable by said production process.

Within polyurethane coating technology, certain secondary polyamines containing ester groups have become established in recent years that, in combination with paint polyisocyanates, are particularly suitable as binders in low-solvent or solvent-free (high-solids) coating compositions and allow rapid curing of the coatings at low temperatures. These secondary polyamines are so-called polyaspartic esters, as described for example in EP0403921. Their use in coating compositions, optionally in a mixture with further components that are reactive toward isocyanate groups, is described for example in EP0403921, EP0639628, EP0667362, EP0689881, U.S. Pat. No. 5,214,086, EP0699696, EP0596360, EP0893458, DE19701835, and U.S. Pat. No. 5,243,012.

However, cured coatings based on polyaspartic-acid-containing coating compositions of this kind exhibit poor adhesion to critical metallic surfaces. Appropriate coating compositions have accordingly been developed that result in coatings with improved adhesion. Such a coating composition is described in WO 2010/112157 A1. This is a coating composition based on silane-modified polyisocyanates having allophanate groups in a mixture with polyaspartic esters. The coating compositions comprise pigments and can be applied more than once to obtain multilayer systems that comprise pigments in all layers. However, after curing, these systems have been found to exhibit inadequate gloss retention when exposed to weathering and also inadequate water resistance.

The object of the present invention was therefore to provide multilayer systems that after curing exhibit good adhesion to critical metallic surfaces and in addition exhibit good gloss retention when exposed to weathering and also high water resistance.

This object was achieved by the layer structures of the invention as described hereinbelow.

KR-2018-0036827 A describes a multilayer system consisting of a primer based on silane-modified polyisocyanates and aspartates and an aspartate-based topcoat, with pigments present in all layers. The multilayer system is used for coating buildings.

WO 2014/138052 A1 describes multilayer systems in which the individual layers are based on polyaspartates and on silanes modified with epoxy groups and polyisocyanates. The topcoat comprises pigments.

None of these documents disclose a layer structure corresponding to the description hereinbelow that after curing ensures good adhesion to critical metallic surfaces and additionally good gloss retention when exposed to weathering and also high water resistance, nor is this suggested by any of these documents or any combination of these documents.

The present invention provides a layer structure comprising or consisting of at least one partially cured or fully cured coating composition for a pigmented coating (B_{P}) and at least one coating composition for a clearcoat (B_{K}) applied thereon,

where
i) the at least one coating composition B_{P} comprises the following components:
   A) at least one polyaspartic-ester-containing component, comprising
      A1) one or more polyaspartic esters of the general formula (I)

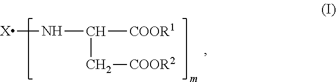

in which
X is an m-valent organic radical, optionally containing one or more heteroatoms, as can be obtained by removing the primary amino groups from a corresponding polyamine that has (cyclo)aliphatically or araliphatically attached primary amino groups and is in the molecular weight range from ≥60 to ≤6000 g/mol and that may contain further functional groups reactive toward isocyanate groups and/or functional groups inert at temperatures of up to 100° C.,
R¹ and R² are identical or different organic radicals each having 1 to 18 carbon atoms,
m is an integer ≥1,
and
A2) optionally one or more polyaspartic esters having a primary amino group that are of the general formula (II)

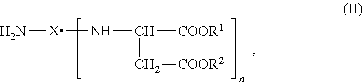

in which
n is m−1,
X and the radicals R¹ and R² are as defined above, and
A3) optionally one or more dialkyl fumarates,
B) optionally at least one component reactive toward isocyanate groups that is different from A,
C) at least one silane-functional polyisocyanate containing at least one silane group of the general formula (III)

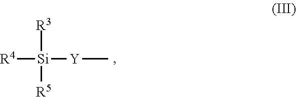

in which
R³, R⁴, and R⁵ are identical or different radicals and are each a saturated or unsaturated, linear or branched, aliphatic or cycloaliphatic radical or optionally substituted aromatic or araliphatic radical having up to 18 carbon atoms, which may optionally contain up to 3 heteroatoms from the group of oxygen, sulfur, and nitrogen, and
Y is a linear or branched organic radical having at least 2 carbon atoms that may optionally contain up to 2 imino groups (—NH—),
D) optionally at least one polyisocyanate different from C,
E) at least one pigment,
F) optionally further auxiliaries and additives,
and
ii) the at least one coating composition B_{K} comprises the following components:
   G) at least one polyaspartic-ester-containing component, comprising
      G1) one or more polyaspartic esters of the general formula (IV)

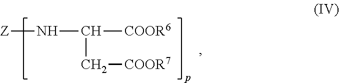

in which
X is a p-valent organic radical, optionally containing one or more heteroatoms, as can be obtained by removing the primary amino groups from a corresponding polyamine that has (cyclo)aliphatically or araliphatically attached primary amino groups and is in the molecular weight range from ≥60 to ≤6000 g/mol and that may contain further functional groups reactive toward isocyanate groups and/or functional groups inert at temperatures of up to 100° C.,
R⁶ and R⁷ are identical or different organic radicals each having 1 to 18 carbon atoms,
p is an integer ≥1,
and
G2) optionally one or more polyaspartic esters having a primary amino group that are of the general formula (V)

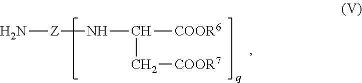

in which
q is p−1,
Z and the radicals R⁶ and R⁷ are as defined above,
and
G3) optionally one or more dialkyl fumarates,
H) optionally at least one component reactive toward isocyanate groups that is different from G,
I) at least one polyisocyanate,
J) optionally auxiliaries and additives.

In an alternative embodiment, the at least one coating composition B_{P} consists of components A to F and the at least one coating composition B_{K} comprises components G to J.

In a further alternative embodiment, the at least one coating composition B_{P} comprises components A to F and the at least one coating composition B_{K} consists of components G to J.

In a further alternative embodiment, the at least one coating composition B_{P} consists of components A to F and the at least one coating composition B_{K} consists of components G to J.

### Coating Composition for a Pigmented Coating (B_{P})

### Polyaspartic-Ester-Containing Component A

Prior art: The preparation of amino-functional aspartic esters is known in principle.

The synthesis is carried out through addition of primary polyamines to an activated carbon-carbon double bond of vinylogous carbonyl compounds, as present for example in maleic or fumaric esters, which is adequately described in the literature (Houben-Weyl, Meth. d. Org. Chemie vol. 11/1, 272 (1957), Usp. Khim. 1969, 38, 1933). If only one amino group of the polyamine has reacted with the double bond of the vinylogous carbonyl compounds, this reaction can result in the formation, as a side product, of a polyaspartic ester having primary amino groups. In the commercially available polyaspartic esters, maleic ester is used as the vinylogous carbonyl compound. During preparation of a polyaspartic ester based on maleic esters, a retro-Michael addition can occur as a further undesired side reaction in which elimination of the polyamine results in the formation of dialkyl fumarate as a minor component. Dialkyl fumarates can cause severe sensitization and are for example classified as VOCs (volatile organic compounds). They should therefore if possible be eliminated from the product before it is supplied to the customer. A typical production process for a polyaspartic ester therefore requires a storage time of 4-6 weeks once most of the reactants have reacted with one another. During this time, the product undergoes so-called maturation, which is manifested by stabilization of the viscosity. Because conversion continues to increase during this time, the dialkyl fumarate content falls too. This storage over several weeks incurs significant logistics costs during production. Moreover, even after storage the product often still contains substantial amounts of dialkyl fumarates. In recent years, special distillation methods have been developed with which the dialkyl fumarate content of the products can be reduced to significantly lower values without lengthy storage (WO 2019/057621 A1 and WO 2019/0576217 A1).

The polyaspartic-ester-containing components A to be used according to the invention preferably comprise one or more polyaspartic esters of the general formulas (I) and optionally (II) in which R¹ and R² are identical or different alkyl radicals each having 1 to 18 carbon atoms, preferably identical or different alkyl radicals each having 1 to 8 carbon atoms, and most preferably in each case alkyl radicals such as methyl, ethyl, propyl, isopropyl, butyl or isobutyl radicals. Most preferred is ethyl.

Polyaspartic-ester-containing components A comprise one or more polyaspartic esters of the general formulas (I) and optionally (II) in which X is derived from polyamines of the general formula (VI):

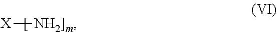

where X
is an m-valent organic radical, optionally containing one or more heteroatoms, as can be obtained by removing the primary amino groups from a polyamine that has (cyclo)aliphatically or araliphatically attached primary amino groups and is in the molecular weight range from ≥60 to ≤6000 g/mol and that may contain further functional groups reactive toward isocyanate groups and/or functional groups inert at temperatures of up to 100° C., and
m is an integer ≥1, preferably 2.

Examples include the following compounds: ethylenediamine, 1,2-diaminopropane, 1,4-diaminobutane, 1,5-diaminopentane, 2,5-diamino-2,5-dimethylhexane, 1,5-diamino-2-methylpentane (Dytek® A, from DuPont), 1,6-diaminohexane, 2,2,4- and/or 2,4,4-trimethyl-1,6-diaminohexane, 1,11-diaminoundecane, 1,12-diaminododecane or triaminononane, etheramines such as 4,9-dioxadodecane-1,12-diamine, 4,7,10-trioxatridecane-1,13-diamine or higher-molecular-weight polyether polyamines having aliphatically attached primary amino groups, for example those marketed under the Jeffamine® name by Huntsman. Also employable are aliphatic polycyclic polyamines such as tricyclodecanebismethylamine (TCD diamine) or bis(aminomethyl)norbornanes, amino-functional siloxanes, for example diaminopropylsiloxane G10 DAS (from Momentive), oleoalkyl-based amines, for example Fentamine from Solvay, and dimeric fatty acid diamines such as Priamine from Croda.

Polyaspartic-ester-containing components A preferably comprise one or more polyaspartic esters of the general formulas (I) and optionally (II), in which X represents organic radicals obtained by removing the primary amino groups from one of the polyamines of the general formula (VI) in which m=2 and X is a cyclic hydrocarbon radical containing at least one cyclic carbon ring. Examples of diamines that may be used with particular preference are 1-amino-3,3,5-trimethyl-5-aminomethylcyclohexane (IPDA), 2,4- and/or 2,6-hexahydrotolylenediamine (H6-TDA), isopropyl-2,4-diaminocyclohexane and/or isopropyl-2,6-diaminocyclohexane, 1,3-bis(aminomethyl)cyclohexane, 2,4′-, and/or 4,4′-diaminodicyclohexylmethane, 3,3′-dimethyl-4,4′-diaminodicyclohexylmethane (Laromin® C 260, BASF AG), the isomeric diaminodicyclohexylmethanes substituted in the ring with a methyl group (=C-monomethyl-diaminodicyclohexylmethanes), 3(4)-aminomethyl-1-methylcyclohexylamine (AMCA) and also araliphatic diamines such as 1,3-bis(aminomethyl)benzene or m-xylylenediamine.

Polyaspartic-ester-containing components A likewise preferably comprise one or more polyaspartic esters of the general formulas (I) and optionally (II) in which X represents organic radicals obtained by removing the primary amino groups from one of the polyamines of the general formula (VI), selected from the group: polyether polyamines having aliphatically attached primary amino groups, 1,2-diaminopropane, 1,4-diaminobutane, 1,6-diaminohexane, 1,5-diamino-2-methylpentane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 1,5-diaminopentane, 2,4′- and/or 4,4′-diaminodicyclohexylmethane or 3,3′-dimethyl-4,4′-diaminodicyclohexylmethane. Particular preference is given to 3,3′-dimethyl-4,4′-diaminodicyclohexylmethane, 1,5-diaminopentane, 2,4′- and/or 4,4′-diaminodicyclohexylmethane, 1,5-diamino-2-methylpentane, and very particular preference to using 2,4′- and/or 4,4′-diaminodicyclohexylmethane.

Polyaspartic-ester-containing components A particularly preferably comprise one or more polyaspartic esters of the general formulas (I) and optionally (II) in which X represents organic radicals obtained by removing the primary amino groups from one of the polyamines of the general formula (VI), selected from the group: polyether polyamines having aliphatically attached primary amino groups, 1,2-diaminopropane, 1,4-diaminobutane, 1,5-diaminopentane, 1,6-diaminohexane, 1,5-diamino-2-methylpentane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 2,4′- and/or 4,4′-diaminodicyclohexylmethane or 3,3′-dimethyl-4,4′-diaminodicyclohexylmethane.

Polyaspartic-ester-containing components A very particularly preferably comprise one or more polyaspartic esters of the general formulas (I) and optionally (II) in which X represents organic radicals obtained by removing the primary amino groups from one of the polyamines of the general formula (VI), selected from the group: 3,3′-dimethyl-4,4′-diaminodicyclohexylmethane, 2,4′- and/or 4,4′-diaminodicyclohexylmethane, and 1,5-diamino-2-methylpentane.

Where the polyaspartic-ester-containing component A comprises one or more polyaspartic esters of the general formula (II), these are present in a proportion of ≥0%, preferably not less than 0.1% (≥0.1%), more preferably not less than 1% (≥1%), most preferably not less than 4% (≥4%), and preferably not more than 20% (≤20%), more preferably not more than 15% (≤15%), of the area by GC (measured as area % in the gas chromatogram), where the sum of the areas by GC of compounds of the two general formulas (I) and (II) is 100%. Any combination of the specified upper and lower limits is possible. All possible combinations are considered disclosed.

Where the polyaspartic-ester-containing component A contains dialkyl fumarate(s) (component A3), this is/they are present in amounts of ≥0% by weight, preferably ≥0.01% to ≤3% by weight, more preferably ≥0.01% to ≤1.5% by weight, even more preferably ≥0.01% to ≤1.3% by weight, more preferably still ≥0.01% to ≤1% by weight, most preferably ≥0.01% to ≤0.1% by weight, based on the total weight of component A.

Polyaspartic-ester-containing components A preferably comprise one or more polyaspartic esters of the general formulas (I) and optionally (II), where the esters have a platinum-cobalt color index ≤200, more preferably ≤100. The platinum-cobalt color index is measured in accordance with DIN EN ISO 6271:2016-05.

The polyaspartic-ester-containing components A to be used according to the invention can be prepared by the following process:

reaction of polyamines of the general formula (VI),

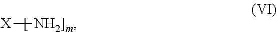

where X
is an m-valent organic radical, optionally containing one or more heteroatoms, as can be obtained by removing the primary amino groups from a polyamine that has (cyclo)aliphatically or araliphatically attached primary amino groups and is in the molecular weight range from ≥60 to ≤6000 g/mol and that may contain further functional groups reactive toward isocyanate groups and/or functional groups inert at temperatures of up to 100° C.,
m is an integer ≥1, preferably 2,
   with compounds of the general formula (VII)

R¹OOC—CH═CH—COOR² (VII),
where R¹ and R²
are identical or different organic radicals, preferably identical or different alkyl radicals each having 1 to 18 carbon atoms, more preferably identical or different alkyl radicals each having 1 to 8 carbon atoms, very particularly preferably in each case alkyl radicals such as methyl, ethyl, propyl, isopropyl, butyl or isobutyl radicals and most preferably ethyl,
   and removal by distillation of the unreacted fraction of the compound of the general formula (VII).

The process described above for the preparation of polyaspartic-ester-containing components A is preferably carried out in two steps. In the first step, the compounds of the general formula (VI) and (VII) are reacted at temperatures between 0° C. and 100° C., preferably 20° to 80° C., and more preferably 20° to 60° C., in a ratio of equivalents of primary amino groups in the compounds of the general formula (VI) to C═C double bond equivalents in the compounds of the general formula (VII) of 1:1.2 to 1.2:1, but preferably 1:1.05 to 1.05:1, more preferably 1:1, until the residual content of compounds of the general formula (VII) is from 2 to 15 percent by weight, preferably from 3 to 10 percent by weight.

In the second step, the unreacted fraction of the compounds of the general formula (VII) is removed by distillation.

Polyaspartic-ester-containing components A that comprise only polyaspartic esters of the general formula (I), but not of the formula (II), or that are virtually free of polyaspartic esters of the general formula (II), can be prepared in analogous manner, but employing an excess of compounds of the general formula (VII), i.e. in a ratio of equivalents of primary amino groups in the compounds of the general formula (VI) to C═C double bond equivalents in the compounds of the general formula (VII) of 1:10, preferably 1:5, more preferably 1:2.

Suitable conditions during the distillation are a pressure range of between 0.01 and 2 mbar and a temperature in the bottom outflow on exiting the distillation apparatus of ≤170° C. and ≥the temperature resulting from the following formula (VIII):

$$T ( bottom outflow ) = 27 \times ln ( p ) + 150 \qquad ( VIII )$$

$$\begin{matrix}where T ( bottom outflow ) & is the temperature of the bottom outflow in °C and \\ p & is the pressure in the distillation apparatus in m bar .\end{matrix}$$

Maintaining this pressure range ensures not only that moderate temperatures in the bottom outflow are sufficient for depletion of the dialkyl fumarate content to the desired extent, but that the process remains usable on an industrial scale. At lower pressure, the gas density becomes too low and the necessary apparatus consequently so large that the process becomes economically disadvantageous.

The temperature of the bottom outflow is preferably ≤170° C., but at least 20 K above the temperature resulting from formula (VIII); more preferably between 20 K and 40 K above the temperature resulting from formula (VIII), but not higher than 170° C.

With regard to examples and preferred ranges of polyamines of the general formula (VI) that may be used in the process described above, we refer to the preceding statements.

Preferred compounds of the general formula (VII) that are used in the process described above are maleic or fumaric esters of the general formula (VII) in which R¹ and R² are identical or different organic radicals each having 1 to 18 carbon atoms. Preferably, R¹ and R² are independently linear or branched alkyl radicals having 1 to 8 carbon atoms, more preferably they are each alkyl radicals such as methyl, ethyl, propyl, isopropyl, butyl or isobutyl radicals and most preferably ethyl.

Examples of compounds of the general formula (VII) include the following compounds: dimethyl maleate, diethyl maleate, di-n-propyl or diisopropyl maleate, di-n-butyl maleate, di-2-ethylhexyl maleate or the corresponding fumaric esters. Very particular preference is given to diethyl maleate.

### Components B

In addition to the at least one polyaspartic-ester-containing component A, the coating composition B_{P} may comprise further components (B) reactive toward isocyanate groups.

These may for example be low-molecular-weight polyols in the molecular weight range from 62 to 300 g/mol, for example ethylene glycol, propylene glycol, trimethylolpropane, glycerol or mixtures of these alcohols, or polyhydroxy compounds having a molecular weight of above 300 g/mol, preferably above 400 g/mol, more preferably between 400 and 20000 g/mol. Such polyhydroxyl compounds are in particular those having 2 to 6, preferably 2 to 3, hydroxyl groups per molecule and are selected from the group consisting of ether, ester, thioether, polyurethane, carbonate, and polyacrylate polyols and mixtures of such polyols. Preference is given to polyhydroxyl compounds of the abovementioned kind.

### Components C

The coating composition B_{P} comprises as component C at least one silane-functional polyisocyanate containing at least one silane group of the general formula (III)

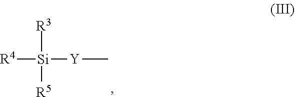

in which
R³, R⁴, and R⁵ are identical or different radicals and are each a saturated or unsaturated, linear or branched, aliphatic or cycloaliphatic radical or optionally substituted aromatic or araliphatic radical having up to 18 carbon atoms, which may optionally contain up to 3 heteroatoms from the group of oxygen, sulfur, and nitrogen, and
Y is a linear or branched organic radical having at least 2 carbon atoms that may optionally contain up to 2 imino groups (—NH—).

Preference is given to using silane-functional polyisocyanates (C) obtainable by reacting
(C1) at least one polyisocyanate with
(C2₁) at least one compound reactive toward isocyanate groups of the general formula (IX)

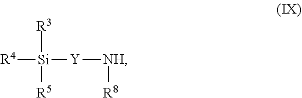

in which
R³, R⁴, R⁵, and Y are as defined for formula (III) and
R⁸ is hydrogen, a saturated or unsaturated, linear or branched, aliphatic or cycloaliphatic radical or an optionally substituted aromatic or araliphatic radical having up to 18 carbon atoms, or|
   i) a radical of the formula

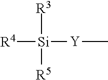

in which R³, R⁴, R⁵, and Y are as defined for formula (III), or|
ii) a radical of the formula

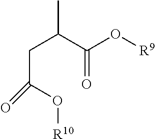

in which R⁹ and R¹⁰ are independently saturated or unsaturated, linear or branched, aliphatic or cycloaliphatic or aromatic organic radicals having 1 to 18 carbon atoms that may be substituted or unsubstituted and/or have heteroatoms in the chain,
iii) a radical of the formula

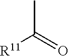

in which R¹¹ is hydrogen or a saturated linear or branched, aliphatic or cycloaliphatic organic radical having 1 to 8 carbon atoms,
or of the general formula (X)

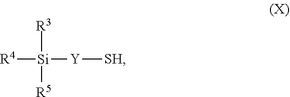

in which R³, R⁴, and R⁵ are as defined for formula (III) and
Y is a linear or branched organic radical having at least 2 carbon atoms,
or
(C2₂) at least one hydroxyurethane and/or hydroxyamide containing silane groups obtainable from the reaction of aminosilanes with cyclic carbonates or lactones.

### Polyisocyanates C1

Suitable starting compounds C1 for preparing the silane-functional polyisocyanates (C) are any desired monomeric diisocyanates having aliphatically, cycloaliphatically, araliphatically and/or aromatically attached isocyanate groups, which may be produced by any desired processes, for example by phosgenation or by a phosgene-free route, for example by urethane cleavage.

Suitable monomeric diisocyanates are for example those of the general formula (XI)

OCN-Q-NCO (XI),

in which Q is a linear or branched, aliphatic or cycloaliphatic radical having up to 18 carbon atoms, preferably 4 to 18 carbon atoms, or an optionally substituted aromatic or araliphatic radical having up to 18 carbon atoms, preferably 5 to 18 carbon atoms, for example 1,4-diisocyanatobutane, 1,5-diisocyanatopentane (PDI), 1,6-diisocyanatohexane (HDI), 1,5-diisocyanato-2,2-dimethylpentane, 2,2,4- or 2,4,4-trimethyl-1,6-diisocyanatohexane, 1,8-diisocyanatooctane, 1,9-diisocyanatononane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₁₂-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene, 1,3- and 1,4-bis(1-isocyanato-1-methylethyl)benzene (TMXDI), bis(4-(1-isocyanato-1-methylethyl)phenyl) carbonate, phenylene 1,3- and 1,4-diisocyanate, tolylene 2,4- and 2,6-diisocyanate, and any desired mixtures of these isomers, diphenylmethane 2,4′- and/or 4,4′-diisocyanate and naphthylene 1,5-diisocyanate and any desired mixtures of such diisocyanates. Further diisocyanates that are likewise suitable can also be found for example in Justus Liebigs Annalen der Chemie, volume 562 (1949) pp. 75-136.

Particular preference is given to monomeric diisocyanates of the general formula (IV) in which Z is a linear or branched, aliphatic or cycloaliphatic radical having 5 to 13 carbon atoms.

Very particularly preferred monomeric diisocyanates for preparing the silane-functional polyisocyanates (C) are 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane or any desired mixtures of these diisocyanates.

In addition to the abovementioned monomeric diisocyanates, suitable starting compounds C1 for preparing the silane-functional polyisocyanates (C) also include any desired oligomeric di- and polyisocyanates having uretdione, isocyanurate, urethane, allophanate, thiourethane, thioallophanate, biuret, urea, iminooxadiazinedione and/or oxadiazinetrione structures obtainable by modifying monomeric aliphatic, cycloaliphatic, araliphatic and/or aromatic diisocyanates, or any desired mixtures of these oligomeric di- and polyisocyanates. These oligomeric compounds are prepared according to methods for isocyanate oligomerization known per se, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053, and DE-A 3 928 503 or in EP-A 0 336 205, EP-A 0 339 396 and EP-A 0 798 299 and also in DE-A 870 400, DE-A 953 012, DE-A 1 090 196, EP-A 0 546 399, CN 105218780, CN 103881050, CN 101717571, U.S. Pat. No. 3,183,112, EP-A 0 416 338, EP-A 0 751 163, EP-A 1 378 529, EP-A 1 378 530, EP-A 2 174 967, JP 63260915, and JP 56059828 by way of example. Suitable monomeric diisocyanates include for example the abovementioned diisocyanates. The abovementioned preferred ranges apply here.

### Compounds C2₁ Reactive Toward Isocyanate Groups (=Isocyanate-Reactive Compounds)

Suitable starting compounds C2₁ for preparing the silane-functional polyisocyanates (C) are for example aminosilanes of the general formula (IX)

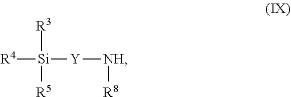

in which
R³, R⁴, R⁵, R⁸, and Y are as defined above for formula (IX).

Suitable aminosilanes of the general formula (IX) are for example 3-aminopropyltrimethoxysilane, 3-aminopropyltriethoxysilane, 3-aminopropylmethyldimethoxysilane, 3-aminopropylmethyl-diethoxysilane, 3-aminopropylethyldiethoxysilane, 3-aminopropyldimethylethoxysilane, 3-aminopropyldiisopropylethoxysilane, 3-aminopropyltripropoxysilane, 3-aminopropyltributoxy-silane, 3-aminopropylphenyldiethoxysilane, 3-aminopropylphenyldimethoxysilane, 3-aminopropyltris(methoxyethoxyethoxy)silane, 2-aminoisopropyltrimethoxysilane, 4-aminobutyltrimethoxysilane, 4-aminobutyltriethoxysilane, 4-aminobutylmethyldimethoxysilane, 4-aminobutylmethyldiethoxysilane, 4-aminobutylethyldimethoxysilane, 4-aminobutylethyl-diethoxysilane, 4-aminobutyldimethylmethoxysilane, 4-aminobutylphenyldimethoxysilane, 4-aminobutylphenyldiethoxysilane, 4-amino(3-methylbutyl)methyldimethoxysilane, 4-amino(3-methylbutyl)methyldiethoxysilane, 4-amino(3-methylbutyl)trimethoxysilane, 3-aminopropylphenylmethyl-n-propoxysilane, 3-aminopropylmethyldibutoxysilane, 3-aminopropyldiethylmethylsilane, 3-aminopropylmethylbis(trimethylsiloxy)silane, 11-aminoundecyltrimethoxysilane, N-methyl-3-aminopropyltrimethoxysilane, N-methyl-3-aminopropyltriethoxysilane, N-(n-butyl)-3-aminopropyltrimethoxysilane, N-(n-butyl)-3-aminopropyltriethoxysilane, N-(2-aminoethyl)-3-aminopropyltrimethoxysilane, N-(2-aminoethyl)-3-aminoisobutylmethyldimethoxysilane, N-(2-aminoethyl)-3-aminopropylmethyldimethoxysilane, N-(2-aminoethyl)-3-aminopropyltris(2-ethylhexoxy)silane, N-(6-aminohexyl)-3-aminopropyltrimethoxysilane, N-benzyl-N-(2-aminoethyl)-3-aminopropyltrimethoxysilane, bis(3-trimethoxysilylpropyl)amine, bis(3-triethoxysilylpropyl)amine, (aminoethylaminomethyl)phenethyltrimethoxysilane, N-vinylbenzyl-N-(2-aminoethyl)-3-aminopropylpolysiloxane, N-vinylbenzyl-N-(2-aminoethyl)-3-aminopropylpolysiloxane, 3-ureidopropyltriethoxysilane, 3-(m-aminophenoxy)propyltrimethoxysilane, m- and/or p-aminophenyltrimethoxysilane, 3-(3-aminopropoxy)-3,3-dimethyl-1-propenyltrimethoxysilane, 3-aminopropylmethylbis(trimethylsiloxy)silane, 3-aminopropyltris(trimethylsiloxy)silane, 3-aminopropylpentamethyldisiloxane or any desired mixture of such aminosilanes.

Preference among these is given to aminosilanes of the general formula (IX) in which
R³, R⁴, and R⁵ are each alkyl radicals having up to 6 carbon atoms and/or alkoxy radicals containing up to 3 oxygen atoms, with the proviso that at least one of the radicals R¹, R², and R³ is an alkoxy radical of this kind,
X is a linear or branched organic radical having at least 2 carbon atoms, and
R⁸ is a saturated, linear or branched, aliphatic or cycloaliphatic radical having up to 6 carbon atoms or a radical of the formula

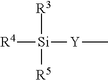

in which R³, R⁴, R⁵, and Y are as defined above.

Particular preference among these is given to aminosilanes of the general formula (IX) in which
R³, R⁴, and R⁵ are each methyl, methoxy and/or ethoxy, with the proviso that at least one of the radicals R¹, R², and R³ is a methoxy or ethoxy radical,
Y is a propylene radical (—CH₂—CH₂—CH₂—), and
R⁸ is a linear alkyl radical having up to 4 carbon atoms or a radical of the formula

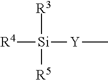

in which R³, R⁴, R⁵, and Y are as defined above.

Very particular preference among these is given to N-methyl-3-aminopropyltrimethoxysilane, N-methyl-3-aminopropyltriethoxysilane, N-(n-butyl)-3-aminopropyltrimethoxysilane, N-(n-butyl)-3-aminopropyltriethoxysilane, bis(3-trimethoxysilylpropyl)amine and/or bis(3-triethoxysilyl-propyl)amine.

Preferred aminosilanes of the general formula (IX) also include for example those in which
R³, R⁴, and R⁵ are each alkyl radicals having up to 6 carbon atoms and/or alkoxy radicals containing up to 3 oxygen atoms, with the proviso that at least one of the radicals R³, R⁴, and R⁵ is an alkoxy radical of this kind,
Y is a linear or branched organic radical having at least 2 carbon atoms, and
R⁸ is a radical of the formula

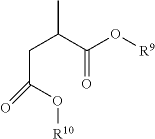

in which
R⁹ and R¹⁰ are independently saturated or unsaturated, linear or branched, aliphatic or cycloaliphatic or aromatic organic radicals having 1 to 18 carbon atoms that are substituted or unsubstituted and/or have heteroatoms in the chain.

Particular preference among these is given to aminosilanes of the general formula (IX) in which
R³, R⁴, and R⁵ are each methyl, methoxy and/or ethoxy, with the proviso that at least one of the radicals R³, R⁴, and R⁵ is a methoxy or ethoxy radical,
Y is a propylene radical (—CH₂—CH₂—CH₂—), and
R⁸ is a radical of the formula

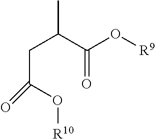

in which R⁹ and R¹⁰ are independently methyl, ethyl, n-butyl or 2-ethylhexyl.

These aminosilanes are the known silane-functional aspartic esters such as those obtainable according to the teaching of EP-A 0 596 360 by reacting aminosilanes bearing primary amino groups with fumaric esters and/or maleic esters.

Suitable starting compounds for preparing these silane-functional aspartic esters are therefore in principle any desired aminosilanes of the general formula (IX)

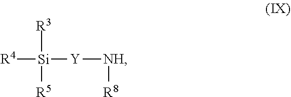

in which R³, R⁴, R⁵, and Y are as defined above for formula (IX) and R⁸ is hydrogen.

These are reacted with fumaric diesters and/or maleic diesters of the general formula (XII)

R⁹OOC—CH═CH—COOR¹⁰ (XII),

in which the radicals R⁹ and R¹⁰ are as defined above.

Very particularly preferred silane-functional aspartic esters are reaction products of 3-aminopropyltrimethoxysilane and/or 3-aminopropyltriethoxysilane with diethyl maleate.

Preferred aminosilanes of the general formula (IX) further include those in which
R³, R⁴, and R⁵ are each alkyl radicals having up to 6 carbon atoms and/or alkoxy radicals containing up to 3 oxygen atoms, with the proviso that at least one of the radicals R³, R⁴, and R⁵ is an alkoxy radical of this kind,
X is a linear or branched organic radical having at least 2 carbon atoms, and
R⁸ is a radical of the formula

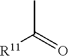

in which R¹¹ is hydrogen or a saturated linear or branched, aliphatic or cycloaliphatic organic radical having 1 to 8 carbon atoms.

Particular preference among these is given to aminosilanes of the general formula (IX) in which
R³, R⁴, and R⁵ are each methyl, methoxy and/or ethoxy, with the proviso that at least one of the radicals R³, R⁴, and R⁵ is a methoxy or ethoxy radical,
Y is a propylene radical (—CH₂—CH₂—CH₂—), and
R⁸ is a radical of the formula

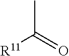

in which
R¹¹ is hydrogen.

These aminosilanes are the known silane-functional alkylamides as obtainable for example according to the processes disclosed in U.S. Pat. Nos. 4,788,310 and 4,826,915 by reacting aminosilanes bearing primary amino groups with alkyl alkylcarboxylates with elimination of alcohol.

Suitable starting compounds for preparing silane-functional alkylamides are therefore in principle any desired aminosilanes of the general formula (IX)

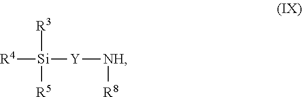

in which R³, R⁴, R⁵, and Y are as defined above for formula (IX) and R⁸ is hydrogen.

These are reacted with alkyl alkylcarboxylates of the general formula (XIII)

R¹¹—COOR¹² (XIII),

in which
R¹¹ is as defined above and
R¹² is a saturated aliphatic organic radical having 1 to 4 carbon atoms.

Very particularly preferred silane-functional alkylamides are reaction products of 3-aminopropyltrimethoxysilane and/or 3-aminopropyltriethoxysilane with methyl formate and/or ethyl formate.

Suitable starting compounds C2₁ for preparing the silane-functional polyisocyanates (C) are also mercaptosilanes of the general formula (X)

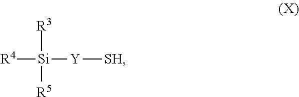

in which R³, R⁴, R⁵, and Y are as defined above for formula (X).

Suitable mercaptosilanes of the general formula (X) are for example 2-mercaptoethyltrimethyl-silane, 2-mercaptoethylmethyldimethoxysilane, 2-mercaptoethyltrimethoxysilane, 2-mercapto-ethyltriethoxysilane, 3-mercaptopropylmethyldimethoxysilane, 3-mercaptopropyldimethyl-methoxysilane, 3-mercaptopropyltrimethoxysilane, 3-mercaptopropylmethyldiethoxysilane, 3-mercaptopropyltriethoxysilane, 3-mercaptopropylethyldimethoxysilane, 3-mercaptopropyl-ethyldiethoxysilane and/or 4-mercaptobutyltrimethoxysilane.

Preferred mercaptosilanes are those of the general formula (X) in which
R³, R⁴, and R⁵ are identical or different radicals and are each a saturated, linear or branched, aliphatic or cycloaliphatic radical having up to 6 carbon atoms that may optionally contain up to 3 oxygen atoms, and
Y is a linear or branched alkylene radical having 2 to 10 carbon atoms.

Particularly preferred mercaptosilanes are those of the general formula (X) in which
R³, R⁴, and R⁵ are each alkyl radicals having up to 6 carbon atoms and/or alkoxy radicals containing up to 3 oxygen atoms, with the proviso that at least one of the radicals R³, R⁴, and R⁵ is an alkoxy radical of this kind, and
Y is a propylene radical (—CH₂—CH₂—CH₂—).

Very particularly preferred mercaptosilanes are those of the general formula (X) in which
R³, R⁴, and R⁵ are identical or different radicals and are each methyl, methoxy or ethoxy, with the proviso that at least one of the radicals R³, R⁴, and R⁵ is a methoxy or ethoxy radical, and
Y is a propylene radical (—CH₂—CH₂—CH₂—),
   especially 3-mercaptopropyltrimethoxysilane and/or 3-mercaptopropyltriethoxysilane.

For preparation of the silane-functional polyisocyanates (C) from components C1 and C2₁, the starting polyisocyanates C1 are reacted with the silane-functional compounds C2₁ at temperatures of 20 to 200° C., preferably 30 to 160° C., more preferably at 35 to 120° C.

These are preferably prepared with observation of an equivalents ratio of isocyanate groups to groups reactive toward isocyanates of 50:1 to 1.05:1, preferably of 20:1 to 1.25:1, more preferably of 10:1 to 1.5:1.

The preparation of the silane-functional polyisocyanates (C) from components C1 and C2₁ can be carried out solvent-free. However, suitable solvents that are inert toward the reactive groups of the starting components can also additionally be used, if desired. Examples of suitable solvents are the customary paint solvents that are known per se, for example ethyl acetate, butyl acetate, ethylene glycol monomethyl or monoethyl ether acetate, 1-methoxy-2-propyl acetate (MPA), 3-methoxy-n-butyl acetate, acetone, 2-butanone, 4-methyl-2-pentanone, cyclohexanone, toluene, xylene, chlorobenzene, white spirit, more highly substituted aromatics of the kind sold for example under the names solvent naphtha, Solvesso®, Isopar®, Nappar® (Deutsche Exxon Chemical GmbH, Cologne, Germany), and Shellsol® (Deutsche Shell Chemie GmbH, Eschborn, Germany), but also solvents such as propylene glycol diacetate, diethylene glycol dimethyl ether, dipropylene glycol dimethyl ether, diethylene glycol ethyl and butyl ether acetate, N-methylpyrrolidone, and N-methylcaprolactam, or any desired mixtures of such solvents.

The reaction of the starting components C1 and C2₁ can be carried out without the use of catalysts. However, especially when using mercaptosilanes (component C2₁, formula X), it may be advantageous to additionally employ suitable catalysts to accelerate the SH—NCO reaction and form thiourethane and/or thioallophanate structures. Suitable catalysts are in particular the customary catalysts known from polyurethane chemistry, examples of which include tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cocomorpholine, N-cyclohexylmorpholine, N,N,N′,N′-tetramethylethylenediamine, N,N,N′,N′-tetramethylbutane-1,3-diamine, N,N,N′,N′-tetramethylhexane-1,6-diamine, pentamethyl-diethylenetriamine, N-methylpiperidine, N-dimethylaminoethylpiperidine, N,N′-dimethyl-piperazine, N-methyl-N′-dimethylaminopiperazine, 1,2-dimethylimidazole, 2-methylimidazole, N,N-dimethylimidazole-β-phenylethylamine, 1,4-diazabicyclo[2.2.2]octane (DABCO) and bis(N,N-dimethylaminoethyl) adipate, amidines, for example 1,5-diazabicyclo[4.3.0]nonene (DBN), 1,8-diazabicyclo[5.4.0]undec-7-ene (DBU), and 2,3-dimethyl-3,4,5,6-tetrahydropyrimidine, alkanolamine compounds, for example triethanolamine, triisopropanolamine, N-methyldiethanolamine, N-ethyldiethanolamine, dimethylaminoethanol, and 2-(N,N-dimethylaminoethoxy)ethanol, N,N′,N″-tris(dialkylaminoalkyl)hexahydrotriazines, for example N,N′,N″-tris(dimethylaminopropyl)-s-hexahydrotriazine, bis(dimethylaminoethyl) ether, and also metal salts, for example inorganic and/or organic compounds of iron, lead, bismuth, zinc and/or tin in the usual oxidation states of the metal, for example iron(II) chloride, iron(III) chloride, bismuth(III) bismuth(III) 2-ethylhexanoate, bismuth(III) octoate, bismuth(III) neodecanoate, zinc chloride, zinc 2-ethylcaproate, tin(II) octoate, tin(II) ethylcaproate, tin(II) palmitate, dibutyltin(IV) dilaurate (DBTL), dibutyltin(IV) dichloride or lead octoate.

Catalysts to be used with preference are tertiary amines, amidines, and tin compounds of the type mentioned.

Particularly preferred catalysts are 1,4-diazabicyclo[2.2.2]octane (DABCO), 1,5-diazabicyclo[4.3.0]nonene (DBN), 1,8-diazabicyclo[5.4.0]undecene-7 (DBU), and dibutyltin(IV) dilaurate (DBTL).

For the preparation of the polyisocyanates containing silane groups, the catalysts mentioned by way of example can be used individually or in the form of any desired mixtures with one another and are used, if at all, in amounts of 0.001% to 1.0% by weight, preferably 0.01% to 0.5% by weight, calculated as the total amount of catalysts used based on the total amount of starting compounds used.

Detailed synthesis routes for the synthesis of silane-functional polyisocyanates (C) based on the reaction of mercaptosilanes of formula X (C2₁) with polyisocyanates of component C1 to form thiourethane structures and thioallophanate structures are described in EP-B 2892905 and WO15/189164 respectively, to which reference is made here.

Detailed synthesis routes for the synthesis of silane-functional polyisocyanates (C) based on the reaction of aminosilanes of formula IX (C2₁) with polyisocyanates of component C1 are described in WO16/146474, to which reference is made here.

In a preferred embodiment, the at least one silane-functional polyisocyanate (C) has thioallophanate structures.

In a particularly preferred embodiment, the at least one silane-functional polyisocyanate (C) has thioallophanate structures based on the reaction of monomeric aliphatic diisocyanate with a mercaptosilane of the formula X.

In a very particularly preferred embodiment, the monomeric aliphatic diisocyanate is PDI and/or HDI. In an alternative very particularly preferred embodiment, the mercaptosilane is mercaptopropyltrimethoxysilane. Most preferably, the monomeric diisocyanate used is HDI and the mercaptosilane used is mercaptopropyltrimethoxysilane.

Hydroxyurethane and Hydroxyamides (C2₂) Containing Silane Groups, Obtainable from the Reaction of Aminosilanes with Cyclic Carbonates or Lactones

Silane-functional polyisocyanates (C) to be used according to the invention are also obtainable by reacting
(C1) at least one polyisocyanate with
(C2₂) at least one hydroxyurethane and/or hydroxyamide containing silane groups obtainable from the reaction of aminosilanes with cyclic carbonates or lactones.

This reaction produces silane-functional allophanate polyisocyanates.

Hydroxyurethanes and hydroxyamides in accordance with C2₂ are obtainable by the ring-opening reaction of aminosilanes with cyclic carbonates and lactones respectively.

Suitable aminosilanes for preparing component C2₂ are for example aminosilanes of the formula (IX), which have already been described in detail above in the description of compounds C2₁. The embodiments there apply by analogy with the aminosilanes suitable for preparing component C2₂. Reference is made here to these statements.

Suitable cyclic carbonates are especially those having 3 or 4 carbon atoms in the ring, which may optionally also be substituted, for example 1,3-dioxolan-2-one (ethylene carbonate, EC), 4-chloro-1,3-dioxolan-2-one, 4,5-dichloro-1,3-dioxolan-2-one, 4-methyl-1,3-dioxolan-2-one (propylene carbonate, PC), 4-ethyl-1,3-dioxolan-2-one, 4,5-dimethyl-1,3-dioxolan-2-one, 4,4-dimethyl-1,3-dioxolan-2-one, 4-hydroxymethyl-1,3-dioxolan-2-one (glycerol carbonate), 4-phenoxymethyl-1,3-dioxolan-2-one, 1,3-dioxan-2-one (trimethylene carbonate), 5,5-dimethyl-1,3-dioxan-2-one, 5-methyl-5-propyl-1,3-dioxan-2-one, 5-ethyl-5-(hydroxymethyl)-1,3-dioxan-2-one (TMP carbonate), 4-isopropyl-5,5-dimethyl-1,3-dioxan-2-one (2,2,4-trimethylpentane-1,3-diol carbonate), 4-tert-butyl-5-methyl-1,3-dioxan-2-one (2,4,4-trimethylpentane-1,3-diol carbonate), 2,4-dioxaspiro[5.5]undecan-3-one (cyclohexane-1,1-dimethanol spirocarbonate), or any desired mixtures of such cyclic carbonates. Preferred cyclic carbonates are ethylene carbonate and/or propylene carbonate.

Suitable lactones are for example those having 3 to 6 carbon atoms in the ring, which optionally may also be substituted, for example β-propiolactone, β-butyrolactone, γ-butyrolactone, α-methyl-γ-butyrolactone, γ-valerolactone, γ-phenyl-γ-butyrolactone, α,α-diphenyl-γ-butyrolactone, γ-hexalactone (γ-caprolactone), γ-heptalactone, γ-octalactone, γ-nonalactone, γ-decalactone, γ-undecalactone, γ-dodecalactone, γ-methyl-γ-decanolactone, α-acetyl-γ-butyrolactone, δ-valerolactone, δ-hexanolactone, δ-octanolactone, δ-nonanolactone, δ-decalactone, δ-undecalactone, δ-tridecalactone, δ-tetradecalactone, γ-ethyl-γ-butyl-δ-valerolactone, octahydrocoumarin, ε-caprolactone, γ-phenyl-ε-caprolactone, ε-decalactone, or any desired mixture of such lactones. Preferred lactones are β-propiolactone, γ-butyrolactone, γ-valerolactone, γ-caprolactone and/or ε-caprolactone.

The preparation of the starting compounds C2₂ by reaction of said aminosilanes with the cyclic carbonates or lactones is known per se and can be carried out for example according to the methods described in SU-A 295764, U.S. Pat. No. 4,104,296, EP-A 0 833 830 or WO 1998/018844. In general, the reactants are reacted with one another in equimolar amounts at temperatures of 15 to 100° C., preferably 20 to 60° C. However, it is also possible for one of the components, for example the aminosilane or the cyclic carbonate or lactone, to be used in a molar excess, but preferably in an excess of not more than 10 mol %, more preferably not more than 5 mol %. The hydroxy-functional starting compounds C2₂ thus obtainable, which contain urethane groups when using cyclic carbonates and amide groups when using lactones, are usually colorless low-viscosity liquids.

For the preparation of the silane-functional polyisocyanates (C), the hydroxyurethanes and/or hydroxyamides C2₂ containing silane groups are reacted with the polyisocyanates C1 to form allophanate polyisocyanates at temperatures of 40 to 200° C., preferably 60 to 180° C., with observation of an equivalents ratio of isocyanate groups to groups reactive toward isocyanates of from 4:1 to 50:1, preferably from 5:1 to 30:1.

In addition to the hydroxyl groups in component C2₂ and the urethane groups formed therefrom as an intermediate in the NCO/OH reaction, the urethane groups already present when using hydroxyurethanes are regarded as being “groups reactive toward isocyanates”, since they also react further to give allophanate groups under the reaction conditions.

The preparation of the allophanate polyisocyanates containing silane groups can be carried out uncatalyzed, as a thermally-induced allophanatization. Preference is however given to using suitable catalysts to accelerate the allophanatization reaction. These are the customary known allophanatization catalysts, for example metal carboxylates, metal chelates or tertiary amines of the type described in GB-A 0 994 890, alkylating agents of the type described in U.S. Pat. No. 3,769,318, or strong acids as described by way of example in EP-A 0 000 194.

Suitable allophanatization catalysts are in particular zinc compounds, for example zinc(II) stearate, zinc(II) n-octanoate, zinc(II) 2-ethyl-1-hexanoate, zinc(II) naphthenate or zinc(II) acetylacetonate, tin compounds, such as tin(II) n-octanoate, tin(II) 2-ethyl-1-hexanoate, tin(II) laurate, dibutyltin oxide, dibutyltin dichloride, dibutyltin diacetate, dibutyltin dilaurate, dibutyltin dimaleate or dioctyltin diacetate, zirconium compounds, such as zirconium(IV) 2-ethyl-1-hexanoate, zirconium(IV) neodecanoate, zirconium(IV) naphthenate or zirconium(IV) acetylacetonate, aluminum tri(ethylacetoacetate), iron(III) chloride, potassium octoate, compounds of manganese, cobalt or nickel, and also strong acids, for example trifluoroacetic acid, sulfuric acid, hydrogen chloride, hydrogen bromide, phosphoric acid or perchloric acid, or any desired mixtures of these catalysts.

Also suitable, albeit less preferred, catalysts for preparing the allophanate polyisocyanates containing silane groups are compounds that in addition to the allophanatization reaction also catalyze the trimerization of isocyanate groups to form isocyanurate structures. Such catalysts are described for example in EP-A 0 649 866 page 4, line 7 to page 5, line 15.

Preferred catalysts are zinc compounds and/or zirconium compounds of the type mentioned above. Very particular preference is given to using zinc(II) n-octanoate, zinc(II) 2-ethyl-1-hexanoate and/or zinc(II) stearate, zirconium(IV) n-octanoate, zirconium(IV) 2-ethyl-1-hexanoate and/or zirconium(IV) neodecanoate.

For the preparation of the allophanate polyisocyanates containing silane groups, these catalysts are used, if at all, in an amount of 0.001% to 5% by weight, preferably 0.005% to 1% by weight, based on the total weight of the reactants C1 and C2₂, and may be added either before the start of the reaction or at any point during the reaction.

The allophanate polyisocyanates containing silane groups are preferably prepared solvent-free. Optionally, it is however also possible to additionally use suitable solvents that are inert toward the reactive groups of the starting components. Examples of suitable solvents are the customary paint solvents that are known per se, for example ethyl acetate, butyl acetate, ethylene glycol monomethyl or monoethyl ether acetate, 1-methoxy-2-propyl acetate (MPA), 3-methoxy-n-butyl acetate, acetone, 2-butanone, 4-methyl-2-pentanone, cyclohexanone, toluene, xylene, chlorobenzene, white spirit, more highly substituted aromatics of the kind sold for example under the names solvent naphtha, Solvesso®, Isopar®, Nappar® (Deutsche Exxon Chemical GmbH, Cologne, Germany), and Shellsol® (Deutsche Shell Chemie GmbH, Eschborn, Germany), but also solvents such as propylene glycol diacetate, diethylene glycol dimethyl ether, dipropylene glycol dimethyl ether, diethylene glycol ethyl and butyl ether acetate, N-methylpyrrolidone, and N-methylcaprolactam, or any desired mixtures of such solvents.

Detailed synthesis routes for the synthesis of silane-functional polyisocyanates (C) based on the reaction of hydroxyurethanes and/or hydroxyamides (C2₁) with polyisocyanates of component C1 to form allophanate structures are described in EP-A 2014692, to which reference is made here.

The silane-functional polyisocyanates (C) obtainable from the reaction of components C1 with components C2₁ or C2₂ preferably have an NCO content of from 1.3% to 24.9% by weight, more preferably from 4.0% to 23.5% by weight, most preferably from 5.0% to 21.0% by weight, and an average NCO functionality preferably of from 1.0 to 4.9, more preferably from 1.8 to 4.8, most preferably from 2.0 to 4.5.

Preferably, the silane-functional polyisocyanates (C) do not contain any epoxy groups.

### Component D

In addition to the at least one silane-functional polyisocyanate (component C), the coating composition B_{P} may comprise further polyisocyanates (component D) different from C.

Suitable polyisocyanates (D) are any desired monomeric diisocyanates having aliphatically, cycloaliphatically, araliphatically and/or aromatically attached isocyanate groups, which may be produced by any desired processes, for example by phosgenation or by a phosgene-free route, for example by urethane cleavage.

Suitable monomeric diisocyanates are for example those of the general formula (XIV)

OCN—V—NCO (XIV),

in which V is a linear or branched, aliphatic or cycloaliphatic radical having up to 18 carbon atoms, preferably 4 to 18 carbon atoms, or an optionally substituted aromatic or araliphatic radical having up to 18 carbon atoms, preferably 5 to 18 carbon atoms, for example 1,4-diisocyanatobutane, 1,5-diisocyanatopentane (PDI), 1,6-diisocyanatohexane (HDI), 1,5-diisocyanato-2,2-dimethylpentane, 2,2,4- or 2,4,4-trimethyl-1,6-diisocyanatohexane, 1,8-diisocyanatooctane, 1,9-diisocyanatononane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₁₂-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene, 1,3- and 1,4-bis(1-isocyanato-1-methylethyl)benzene (TMXDI), bis(4-(1-isocyanato-1-methylethyl)phenyl) carbonate, phenylene 1,3- and 1,4-diisocyanate, tolylene 2,4- and 2,6-diisocyanate, and any desired mixtures of these isomers, diphenylmethane 2,4′- and/or 4,4′-diisocyanate and naphthylene 1,5-diisocyanate and any desired mixtures of such diisocyanates. Further diisocyanates that are likewise suitable can also be found for example in Justus Liebigs Annalen der Chemie volume 562 (1949) pp. 75-136.

Particular preference is given to monomeric diisocyanates of the general formula (XIV) in which V is a linear or branched, aliphatic or cycloaliphatic radical having 5 to 13 carbon atoms.

Very particularly preferred monomeric diisocyanates are 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane or any desired mixtures of these diisocyanates.

In addition to the abovementioned monomeric diisocyanates, other suitable polyisocyanates (D) also include any desired oligomeric di- and polyisocyanates having uretdione, isocyanurate, urethane, allophanate, thiourethane, thioallophanate, biuret, urea, iminooxadiazinedione and/or oxadiazinetrione structures obtainable by modifying monomeric aliphatic, cycloaliphatic, araliphatic and/or aromatic diisocyanates, or any desired mixtures of these oligomeric di- and polyisocyanates. These oligomeric compounds are prepared according to methods for isocyanate oligomerization known per se, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053, and DE-A 3 928 503 or in EP-A 0 336 205, EP-A 0 339 396 and EP-A 0 798 299 and also in DE-A 870 400, DE-A 953 012, DE-A 1 090 196, EP-A 0 546 399, CN 105218780, CN 103881050, CN 101717571, U.S. Pat. No. 3,183,112, EP-A 0 416 338, EP-A 0 751 163, EP-A 1 378 529, EP-A 1 378 530, EP-A 2 174 967, JP 63260915, and JP 56059828 by way of example. Suitable monomeric diisocyanates include for example the abovementioned diisocyanates. The abovementioned preferred ranges apply here.

In a preferred embodiment, polyisocyanates used are oligomeric di- and polyisocyanates having uretdione, isocyanurate, urethane, allophanate, thiourethane, thioallophanate, biuret, urea, iminooxadiazinedione and/or oxadiazinetrione structures, or any desired mixtures of these oligomeric di- and polyisocyanates.

In a particularly preferred embodiment, polyisocyanates used are HDI- or PDI-based oligomeric di- and polyisocyanates having uretdione, isocyanurate, urethane, allophanate, thiourethane, thioallophanate, biuret, urea, iminooxadiazinedione and/or oxadiazinetrione structures, or any desired mixtures of these oligomeric di- and polyisocyanates.

In a most preferred embodiment, polyisocyanates used are HDI- or PDI-based oligomeric di- and polyisocyanates having isocyanurate structures.

### Component E

The coating composition B_{P} comprises as component E at least one pigment.

These include purely color-imparting inorganic and organic pigments, and also effect pigments, pigments that can serve as fillers, and pigments that in addition to the abovementioned optical properties also have anticorrosion properties (anticorrosion pigments) and/or have a magnetizing effect. Examples include titanium dioxide, iron oxides, chromium oxides, carbon blacks, azo pigments and copper phthalocyanine pigments, anthraquinone pigments, isoindoilibon pigments, silicon dioxide, magnesium silicate hydrate, kaolin mica, calcium silicate, aluminum oxide and hydroxide, barium sulfate, talc, calcium carbonate, copper pigments, copper/zinc pigments, aluminum pigments, zinc pigments, such as zinc phosphate, zinc aluminum orthophosphate, zinc dust, zinc oxide, zinc phosphosilicate, zinc chromate, and zinc tetraoxychromates, barium chromate, strontium chromate, strontium phosphosilicates, calcium phosphosilicates, barium phosphosilicates, calcium borosilicate, and calcium metasilicate.

A comprehensive review of pigments for coatings is given in “Lehrbuch der Lacke und Beschichtungen [Textbook on paints and coatings], volume II, “Pigmente, Füllstoffe, Farbstoffe” [Pigments, fillers, dyes], H. Kittel, Verlag W. A. Colomb in der Heenemann GmbH, Berlin-Oberschwandorf, 1974, pp. 17-265.

### Auxiliaries and Additives F

The coating composition B_{P} may comprise auxiliaries and additives F.
Auxiliaries and additives F include catalysts that accelerate the reaction between the isocyanate groups and the isocyanate-reactive groups of the components.
These are for example titanium-, zirconium-, bismuth-, tin- and/or iron-containing catalysts, as described by way of example in WO 05058996. It is also possible to add amines or amidines.
In addition, catalysts for the crosslinking of silane groups may be added. These catalysts are any desired compounds that are capable of accelerating the hydrolysis and condensation of alkoxysilane groups or preferably thermally-induced silane condensation. Suitable catalysts for the crosslinking of silane groups are for example acids, as described for example in WO 2007/033786, or bases, as described for example in WO 2006/042658. Also suitable as catalysts for the crosslinking of silane groups are phosphoric and phosphonic esters in amine-blocked form, preferably tertiary amine-blocked form, that release the acidic phosphoric and phosphonic esters again in the temperature range for curing of automotive topcoats and clearcoats, for example in the range from 100 to 150° C. with elimination of the blocking amine, as described for example in WO 2008/074489 and WO 2009/077180. Likewise suitable as catalysts for the crosslinking of silane groups are organic sulfonic acids, which are used in blocked form, for example in amine-neutralized form, or as an adduct with epoxides, as described in DE 2 356 768 B1, and which release the catalytically active sulfonic acids again above 100° C. Other catalysts suitable for the crosslinking of silane groups include tetraalkylammonium carboxylates and also quaternary ammonium and phosphonium polyfluorides, such as those known from EP-A0 798 299, EP-A0 896 009, and EP-A0 962 455 as trimerization catalysts for isocyanate groups, and zinc amidine complexes, which can be prepared according to the method of WO 2014/016019 by reacting one or more zinc(II) biscarboxylates with amidines.
Examples of other suitable auxiliaries and additives (F) include coatings additives, for example light stabilizers such as UV absorbers and sterically inhibited amines (HALS), organic anticorrosion additives, and also stabilizers, defoamers, anti-cratering agents and/or wetting agents, leveling agents, dispersing additives, film-forming aids, reactive diluents, biocides, deaerators, substances for rheology control or fillers, provided the latter are not pigments (these come under component E).

The use of light stabilizers, especially of UV absorbers, for example substituted benzotriazoles, S-phenyltriazines or oxalanilides, and of sterically hindered amines, especially those having a 2,2,6,6-tetramethylpiperidyl structure—referred to as HALS—is described by way of example in A. Valet, Lichtschutzmittel für Lacke [Light stabilizers for paints], Vincentz Verlag, Hanover, 1996.

Organic anticorrosion additives used may for example be 3-aminopropyltriethoxysilane or benzothiazole-2-thiol.

Stabilizers, for example free-radical scavengers, and other polymerization inhibitors such as sterically hindered phenols stabilize paint components during storage and are intended to prevent discoloration during curing.

Wetting and leveling agents improve surface wetting and/or the levelling of coatings.

Dispersants are additives that permit or stabilize dispersion, i.e. the optimal mixing of phases that are not actually miscible. Wetting and dispersing additives used may for example be high-molecular-weight block copolymers or a polyether-modified-siloxane, and leveling and anti-cratering additives used may for example be polyether-modified polydimethylsiloxane or surface-active low-molecular-weight polymers.

Rheology-control additives are important in order to control the properties of the coating composition during application and in the leveling phase on the substrate and are disclosed for example in patent specifications WO 9422968, EP0276501, EP0249201 or WO 9712945.

Reactive diluents used may for example be mono-, bi- or polyfunctional monomers or oligomers, styrene, epoxides, and acrylates.

Water scavengers used may for example be zeolites (aluminosilicates), p-toluenesulfonyl isocyanate, triethyl orthoformate, monooxazolidines or molecular sieves, hydrolysis inhibitors used may for example be carbodiimides, and deaerators used may for example be foam-destroying polymers and polysiloxanes, mineral oil based, or phosphoric esters.

A comprehensive review of coatings additives is given in “Lehrbuch der Lacke und Beschichtungen, volume III, “Lösemittel, Weichmacher, Additive, Zwischenprodukte”, H. Kittel, Verlag W. A. Colomb in der Heenemann GmbH, Berlin-Oberschwandorf, 1976, pp. 237-398.
Solvents are likewise regarded as auxiliaries and additives F. The solvent may be an organic solvent or a mixture of organic solvents, or water or a mixture of organic solvent(s) and water. Suitable solvents should be used in a manner known to those skilled in the art, with this use tailored to the composition and to the application process. Solvents are intended to dissolve the components used and promote the mixing thereof, and to avoid incompatibilities. In addition, during application and curing, they should escape from the coating in a manner tailored to the crosslinking reaction in progress so as to afford a solvent-free coating of optimal appearance and free of defects such as popping or pinholes. Suitable solvents include in particular those used in two-component technology. Examples of organic solvents are aliphatic, cycloaliphatic, and aromatic hydrocarbons, alcohols, glycols, glycol ethers, ketones, and esters, for example solvent naphtha, xylene, methoxypropyl acetate, ethyl acetate, butyl acetate, dipropylene glycol dimethyl ether, butoxypropanol, butyl glycol, butyl diglycol, ethylene glycol, diethyl glycol, butanone, acetone, ethanol, propanol, n-butanol, isobutanol, methyl ethyl ketone or hexanone, and also mixtures of said solvents. When the NCO-reactive component of the composition is in the form of an aqueous dispersion, water is also suitable as solvent or diluent.

Preferably, the molar ratio of NCO groups in component C and optional component D (NCO groups of C/total for C and D) to NH groups in component A is 2:1 to 0.9:1, more preferably 1:1 to 1.3:1.

Preferably, the weight ratio of component C to component D is 2:98 to 1:0. In a particularly preferred embodiment, the weight ratio of component C to component D is 1:1.

Preferably, the content of the polyaspartic-ester-containing component A in the coating composition B_{P} is ≥10% to ≤60% by weight, more preferably ≥15% to ≤30% by weight, most preferably ≥18% to ≤25% by weight, in each case based on the total weight of the coating composition B_{P}.

Where further components B reactive toward isocyanate groups are present in the coating composition B_{P}, the content thereof is preferably up to 50% by weight (≤50% by weight), more preferably ≥2% to ≤30% by weight, most preferably ≥5% to ≤20% by weight, in each case based on the total weight of the coating composition B_{P}.

Preferably, the content of pigments E in the coating composition B_{P} is ≥0.1% to ≤50% by weight, more preferably ≥5% to ≤40% by weight, most preferably ≥10% to ≤30% by weight, in each case based on the total weight of the coating composition B_{P}.

Where auxiliaries and additives F are present in the coating composition B_{P}, the content thereof is preferably up to 50% by weight (≤50% by weight), more preferably ≥5% to ≤40% by weight, most preferably ≥10% to ≤30% by weight, in each case based on the total weight of the coating composition B_{P}.

The coating composition B_{P} of the invention is preferably not a foamable or foam-forming composition. The compositions are preferably not polymerizable by free radicals, especially not photopolymerizable, i.e. the compositions do not cure through free-radical processes, especially not through free-radical polymerization processes initiated by actinic radiation.

The coating composition B_{P} of the invention is produced by methods known per se in paint technology.

An isocyanate-reactive component (K_{R}) and an isocyanate-containing component (K_{C}) are first produced separately by mixing the respective isocyanate-reactive components A and optionally B and by mixing the respective polyisocyanate components C and optionally D. The pigments E and also the auxiliaries and additives F are preferably admixed with the isocyanate-reactive component (K_{R}). The components K_{R} and K_{H} thus produced are not mixed together until immediately before or during application. When mixing takes place before application, it should be noted that the reaction of the constituents commences immediately after mixing. The rate of the reaction varies according to the choice of components and additives. The processing time within which the composition must be applied is also known as the pot life and is defined as the time from mixing of the components until doubling of the flow time; depending on the choice of components, this is in the range from 1 minute to 24 hours, usually in the range from 10 minutes to 8 hours. The pot life is determined by methods known to those skilled in the art.

In a preferred embodiment, the components belonging to the isocyanate-reactive component K_{R} are mixed, optionally accompanied by or followed by dispersion, and are then milled, optionally with cooling. The latter may done using for example a bead mill. Milling may be followed by a sieving step. Preferably, the isocyanate-reactive component (K_{R}) thus obtained rests for at least 24 hours before being contacted with the isocyanate-containing component K_{H}.

The mixing of the components belonging to the isocyanate-reactive component K_{H} can be carried out in tandem with or followed by dispersion.

The mixing of the components belonging to the isocyanate-reactive component K_{R} and of the components belonging to the isocyanate-reactive component K_{H} and the mixing of components K_{R} and K_{H} can be carried out using for example a stirrer system.

Coating Composition for a Clearcoat (B_{K}) In the context of the present invention, a clearcoat is understood as meaning a coating that does not contain pigments. The coating composition B_{K} accordingly likewise does not contain any pigments.

### Polyaspartic-Ester-Containing Component G

The polyaspartic-ester-containing components G preferably comprise one or more polyaspartic esters of the general formulas (IV) and optionally (IV) in which R⁶ and R⁷ are identical or different alkyl radicals each having 1 to 18 carbon atoms, preferably identical or different alkyl radicals each having 1 to 8 carbon atoms, and most preferably in each case alkyl radicals such as methyl, ethyl, propyl, isopropyl, butyl or isobutyl radicals. Most preferred is ethyl.

Polyaspartic-ester-containing components G comprise one or more polyaspartic esters of the general formulas (IV) and optionally (V) in which Z is derived from polyamines of the general formula (XV):

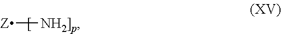

where Z
is a p-valent organic radical, optionally containing one or more heteroatoms, as can be obtained by removing the primary amino groups from a polyamine that has (cyclo)aliphatically or araliphatically attached primary amino groups and is in the molecular weight range from ≥60 to ≤6000 g/mol and that may contain further functional groups reactive toward isocyanate groups and/or functional groups inert at temperatures of up to 100° C.,
p is an integer ≥1, preferably 2.

Examples include the following polyamines: ethylenediamine, 1,2-diaminopropane, 1,4-diaminobutane, 1,5-diaminopentane, 2,5-diamino-2,5-dimethylhexane, 1,5-diamino-2-methylpentane (Dytek® A, from DuPont), 1,6-diaminohexane, 2,2,4- and/or 2,4,4-trimethyl-1,6-diaminohexane, 1,11-diaminoundecane, 1,12-diaminododecane or triaminononane, etheramines such as 4,9-dioxadodecane-1,12-diamine, 4,7,10-trioxatridecane-1,13-diamine or higher-molecular-weight polyether polyamines having aliphatically attached primary amino groups, for example those marketed under the Jeffamine® name by Huntsman. Also employable are aliphatic polycyclic polyamines such as tricyclodecanebismethylamine (TCD diamine) or bis(aminomethyl)norbornanes, amino-functional siloxanes, for example diaminopropylsiloxane G10 DAS (from Momentive), oleoalkyl-based amines, for example Fentamine from Solvay, and dimeric fatty acid diamines such as Priamine from Croda.

Polyaspartic-ester-containing components G preferably comprise one or more polyaspartic esters of the general formulas (IV) and optionally (V) in which Z represents organic radicals obtained by removing the primary amino groups from one of the polyamines of the general formula (XV) in which m=2 and Z is a cyclic hydrocarbon radical containing at least one cyclic carbon ring. Examples of diamines that may be used with particular preference are 1-amino-3,3,5-trimethyl-5-aminomethylcyclohexane (IPDA), 2,4- and/or 2,6-hexahydrotolylenediamine (H6-TDA), isopropyl-2,4-diaminocyclohexane and/or isopropyl-2,6-diaminocyclohexane, 1,3-bis(aminomethyl)cyclohexane, 2,4′-, and/or 4,4′-diaminodicyclohexylmethane, 3,3′-dimethyl-4,4′-diaminodicyclohexylmethane (Laromin® C 260, BASF AG), the isomeric diaminodicyclohexylmethanes substituted in the ring with a methyl group (=C-monomethyl-diaminodicyclohexylmethanes), 3(4)-aminomethyl-1-methylcyclohexylamine (AMCA) and also araliphatic diamines such as 1,3-bis(aminomethyl)benzene or m-xylylenediamine.

Polyaspartic-ester-containing components G likewise preferably comprise one or more polyaspartic esters of the general formulas (IV) and optionally (V) in which Z represents organic radicals obtained by removing the primary amino groups from one of the polyamines of the general formula (XV), selected from the group: polyether polyamines having aliphatically attached primary amino groups, 1,2-diaminopropane, 1,4-diaminobutane, 1,6-diaminohexane, 1,5-diamino-2-methylpentane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 1,5-diaminopentane, 2,4′- and/or 4,4′-diaminodicyclohexylmethane or 3,3′-dimethyl-4,4′-diaminodicyclohexylmethane. Particular preference is given to 3,3′-dimethyl-4,4′-diaminodicyclohexylmethane, 1,5-diaminopentane, 2,4′- and/or 4,4′-diaminodicyclohexylmethane, 1,5-diamino-2-methylpentane, and very particular preference to using 2,4′- and/or 4,4′-diaminodicyclohexylmethane.

Polyaspartic-ester-containing components G particularly preferably comprise one or more polyaspartic esters of the general formulas (IV) and optionally (V) in which Z represents organic radicals obtained by removing the primary amino groups from one of the polyamines of the general formula (XV), selected from the group: polyether polyamines having aliphatically attached primary amino groups, 1,2-diaminopropane, 1,4-diaminobutane, 1,5-diaminopentane, 1,6-diaminohexane, 1,5-diamino-2-methylpentane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 2,4′- and/or 4,4′-diaminodicyclohexylmethane or 3,3′-dimethyl-4,4′-diaminodicyclohexylmethane.

Polyaspartic-ester-containing components G very particularly preferably comprise one or more polyaspartic esters of the general formulas (IV) and optionally (V) in which Z represents organic radicals obtained by removing the primary amino groups from one of the polyamines of the general formula (XV), selected from the group: 3,3′-dimethyl-4,4′-diaminodicyclohexylmethane, 2,4′- and/or 4,4′-diaminodicyclohexylmethane, and 1,5-diamino-2-methylpentane.

Where the polyaspartic-ester-containing component G comprises one or more polyaspartic esters of the general formula (V), this is/these are present in a proportion of >0%, preferably not less than 0.1% (≥0.1%), more preferably not less than 1% (≥1%), most preferably not less than 4% (≥4%), and preferably not more than 20% (≤20%), more preferably not more than 15% (≤15%), of the area by GC (measured as area % in the gas chromatogram), where the sum of the areas by GC of compounds of the two general formulas (IV) and (V) is 100%. Any combination of the specified upper and lower limits is possible. All possible combinations are considered disclosed.

Where the polyaspartic-ester-containing component G contains dialkyl fumarate(s) (component G3), this is/they are present in amounts of >0% by weight, preferably ≥0.01% to ≤3% by weight, more preferably ≥0.01% to ≤1.5% by weight, even more preferably ≥0.01% to ≤1.3% by weight, more preferably still ≥0.01% to ≤1% by weight, most preferably ≥0.01% to ≤0.1% by weight, based on the total weight of component G. With regard to the formation of dialkyl fumarates, reference is made here to the corresponding embodiments in the description of component A.

Polyaspartic-ester-containing components G preferably comprise one or more polyaspartic esters of the general formulas (IV) and optionally (V), where the esters have a platinum-cobalt color index ≤200, more preferably ≤100. The platinum-cobalt color index is measured in accordance with DIN EN ISO 6271:2016-05.

The polyaspartic-ester-containing components G to be used according to the invention can be prepared by the following process:

reaction of polyamines of the general formula (XV),

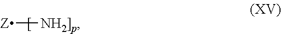

where Z
is a p-valent organic radical, optionally containing one or more heteroatoms, as can be obtained by removing the primary amino groups from a polyamine that has (cyclo)aliphatically or araliphatically attached primary amino groups and is in the molecular weight range from ≥60 to ≤6000 g/mol and that may contain further functional groups reactive to isocyanate groups and/or functional groups inert at temperatures of up to 100° C., p is an integer ≥1, preferably 2,
   with compounds of the general formula (XVI)

R⁶OOC—CH═CH—COOR⁷ (XVI)
where R⁶ and R⁷
are identical or different organic radicals, preferably identical or different alkyl radicals each having 1 to 18 carbon atoms, more preferably identical or different alkyl radicals each having 1 to 8 carbon atoms, very particularly preferably in each case alkyl radicals such as methyl, ethyl, propyl, isopropyl, butyl or isobutyl radicals and most preferably ethyl,
   and removal by distillation of the unreacted fraction of the compound of the general formula (XVI).

The process described above for the preparation of polyaspartic-ester-containing components G is preferably carried out in two steps. In the first step, the compounds of the general formula (XV) and (XVI) are reacted at temperatures between 0° C. and 100° C., preferably 20° to 80° C., and more preferably 20° to 60° C., in a ratio of equivalents of primary amino groups in the compounds of the general formula (XV) to C═C double bond equivalents in the compounds of the general formula (XVI) of 1:1.2 to 1.2:1, but preferably 1:1.05 to 1.05:1, more preferably 1:1, until the residual content of compounds of the general formula (XVI) is from 2 to 15 percent by weight, preferably from 3 to 10 percent by weight

In the second step, the unreacted fraction of the compounds of the general formula (XVI) is removed by distillation.

Polyaspartic-ester-containing components G that comprise only polyaspartic esters of the general formula (IV), but not of the formula (V), or that are virtually free of polyaspartic esters of the general formula (V), can be prepared in analogous manner, but employing an excess of compounds of the general formula (XVI), i.e. in a ratio of equivalents of primary amino groups in the compounds of the general formula (XV) to C═C double bond equivalents in the compounds of the general formula (XVI) of 1:10, preferably 1:5, more preferably 1:2.

With regard to the distillation conditions, what was said in relation to the production of polyaspartic ester-containing components A applies here by analogy.

With regard to examples and preferred ranges of polyamines of the general formula (XV) that may be used in the process described above, we refer to the preceding statements.

Preferred compounds of the general formula (XVI) that are used in the process described above are maleic or fumaric esters of the general formula (XVI) in which R⁶ and R⁷ are identical or different organic radicals each having 1 to 18 carbon atoms. Preferably, R⁶ and R⁷ are independently linear or branched alkyl radicals having 1 to 8 carbon atoms, more preferably each alkyl radicals such as methyl, ethyl, propyl, isopropyl, butyl or isobutyl radicals and most preferably ethyl.

Examples of compounds of the general formula (XVI) include the following compounds: dimethyl maleate, diethyl maleate, di-n-propyl or diisopropyl maleate, di-n-butyl maleate, di-2-ethylhexyl maleate or the corresponding fumaric esters. Very particular preference is given to diethyl maleate.

### Components H

In addition to the at least one polyaspartic-ester-containing component G, the coating composition B_{K} may comprise further components (H) reactive toward isocyanate groups.

These may for example be low-molecular-weight polyols in the molecular weight range from 62 to 300 g/mol, for example ethylene glycol, propylene glycol, trimethylolpropane, glycerol or mixtures of these alcohols, or polyhydroxy compounds having a molecular weight of above 300 g/mol, preferably above 400 g/mol, more preferably between 400 and 20000 g/mol. Such polyhydroxyl compounds are in particular those having 2 to 6, preferably 2 to 3, hydroxyl groups per molecule and are selected from the group consisting of ether, ester, thioether, polyurethane, carbonate, and polyacrylate polyols and mixtures of such polyols. Preference is given to polyhydroxyl compounds of the abovementioned kind.

### Components I

The coating composition B_{K} comprises as component I at least one polyisocyanate.

Suitable polyisocyanates (I) are any desired monomeric diisocyanates having aliphatically, cycloaliphatically, araliphatically and/or aromatically attached isocyanate groups, which may be produced by any desired processes, for example by phosgenation or by a phosgene-free route, for example by urethane cleavage.

Suitable monomeric diisocyanates are for example those of the general formula (XVII)

OCN—W—NCO (XVII),

in which W is a linear or branched, aliphatic or cycloaliphatic radical having up to 18 carbon atoms, preferably 4 to 18 carbon atoms, or an optionally substituted aromatic or araliphatic radical having up to 18 carbon atoms, preferably 5 to 18 carbon atoms, for example 1,4-diisocyanatobutane, 1,5-diisocyanatopentane (PDI), 1,6-diisocyanatohexane (HDI), 1,5-diisocyanato-2,2-dimethylpentane, 2,2,4- or 2,4,4-trimethyl-1,6-diisocyanatohexane, 1,8-diisocyanatooctane, 1,9-diisocyanatononane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₁₂-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene, 1,3- and 1,4-bis(1-isocyanato-1-methylethyl)benzene (TMXDI), bis(4-(1-isocyanato-1-methylethyl)phenyl) carbonate, phenylene 1,3- and 1,4-diisocyanate, tolylene 2,4- and 2,6-diisocyanate, and any desired mixtures of these isomers, diphenylmethane 2,4′- and/or 4,4′-diisocyanate and naphthylene 1,5-diisocyanate and any desired mixtures of such diisocyanates. Further diisocyanates that are likewise suitable can also be found for example in Justus Liebigs Annalen der Chemie volume 562 (1949) pp. 75-136.

Particular preference is given to monomeric diisocyanates of the general formula (XVII) in which W is a linear or branched, aliphatic or cycloaliphatic radical having 5 to 13 carbon atoms.

Very particularly preferred monomeric diisocyanates are 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane or any desired mixtures of these diisocyanates.

In addition to the abovementioned monomeric diisocyanates, other suitable polyisocyanates (I) also include any desired oligomeric di- and polyisocyanates having uretdione, isocyanurate, urethane, allophanate, thiourethane, thioallophanate, biuret, urea, iminooxadiazinedione and/or oxadiazinetrione structures obtainable by modifying monomeric aliphatic, cycloaliphatic, araliphatic and/or aromatic diisocyanates, or any desired mixtures of these oligomeric di- and polyisocyanates. These oligomeric compounds are prepared according to methods for isocyanate oligomerization known per se, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053, and DE-A 3 928 503 or in EP-A 0 336 205, EP-A 0 339 396 and EP-A 0 798 299 and also in DE-A 870 400, DE-A 953 012, DE-A 1 090 196, EP-A 0 546 399, CN 105218780, CN 103881050, CN 101717571, U.S. Pat. No. 3,183,112, EP-A 0 416 338, EP-A 0 751 163, EP-A 1 378 529, EP-A 1 378 530, EP-A 2 174 967, JP 63260915, and JP 56059828 by way of example. Suitable monomeric diisocyanates include for example the abovementioned diisocyanates. The abovementioned preferred ranges apply here.

In a preferred embodiment, oligomeric di- and polyisocyanates having uretdione, isocyanurate, urethane, allophanate, thiourethane, thioallophanate, biuret, urea, iminooxadiazinedione and/or oxadiazinetrione structures, or any desired mixtures of these oligomeric di- and polyisocyanates, are used as polyisocyanates.

In a particularly preferred embodiment, HDI- or PDI-based oligomeric di- and polyisocyanates having uretdione, isocyanurate, urethane, allophanate, thiourethane, thioallophanate, biuret, urea, iminooxadiazinedione and/or oxadiazinetrione structures, or any desired mixtures of these oligomeric di- and polyisocyanates, are used as polyisocyanates.

In a most preferred embodiment, HDI- or PDI-based oligomeric di- and polyisocyanates having isocyanurate structures are used as polyisocyanates.

### Auxiliaries and Additives J

The coating composition B_{K} may comprise auxiliaries and additives J.
Auxiliaries and additives J include catalysts that accelerate the reaction between the isocyanate groups and the isocyanate-reactive groups of the components.
These are for example titanium-, zirconium-, bismuth-, tin- and/or iron-containing catalysts, as described by way of example in WO 05058996. It is also possible to add amines or amidines.
Examples of other suitable auxiliaries and additives (J) include coatings additives, for example light stabilizers such as UV absorbers and sterically inhibited amines (HALS), organic anticorrosion additives, and also stabilizers, defoamers, anti-cratering agents and/or wetting agents, leveling agents, dispersing additives, film-forming aids, reactive diluents, biocides, deaerators, substances for rheology control or fillers, provided the latter are not pigments.
The use of light stabilizers, especially of UV absorbers, for example substituted benzotriazoles, S-phenyltriazines or oxalanilides, and of sterically hindered amines, especially those having a 2,2,6,6-tetramethylpiperidyl structure—referred to as HALS—is described by way of example in A. Valet, Lichtschutzmittel für Lacke [Light stabilizers for paints], Vincentz Verlag, Hanover, 1996.
Organic anticorrosion additives used may for example be 3-aminopropyltriethoxysilane or benzothiazole-2-thiol.
Stabilizers, for example free-radical scavengers, and other polymerization inhibitors such as sterically hindered phenols stabilize paint components during storage and are intended to prevent discoloration during curing.
Wetting and leveling agents improve surface wetting and/or the levelling of coatings.
Dispersants are additives that permit or stabilize dispersion, i.e. the optimal mixing of phases that are not actually miscible. Wetting and dispersing additives used may for example be high-molecular-weight block copolymers or a polyether-modified-siloxane, and leveling and anti-cratering additives used may for example be polyether-modified polydimethylsiloxane or surface-active low-molecular-weight polymers.
Rheology-control additives are important in order to control the properties of the coating composition during application and in the leveling phase on the substrate and are disclosed for example in patent specifications WO 9422968, EP0276501, EP0249201 or WO 9712945.
Reactive diluents used may for example be mono-, bi- or polyfunctional monomers or oligomers, styrene, epoxides, and acrylates.
Water scavengers used may for example be zeolites (aluminosilicates), p-toluenesulfonyl isocyanate, triethyl orthoformate, monooxazolidines or molecular sieves, hydrolysis inhibitors used may for example be carbodiimides, and deaerators used may for example be foam-destroying polymers and polysiloxanes, mineral oil based, or phosphoric esters.
A comprehensive review of coatings additives is given in “Lehrbuch der Lacke und Beschichtungen [Textbook on paints and coatings], volume III, “Ldsemittel, Weichmacher, Additive, Zwischenprodukte” [Solvents, plasticizers, additives, intermediates], H. Kittel, Verlag W. A. Colomb in der Heenemann GmbH, Berlin-Oberschwandorf, 1976, pp. 237-398.
Solvents are likewise regarded as auxiliaries and additives J. The solvent may be an organic solvent or a mixture of organic solvents, or water or a mixture of organic solvent(s) and water. Suitable solvents should be used in a manner known to those skilled in the art, with this use tailored to the composition and to the application process. Solvents are intended to dissolve the components used and promote the mixing thereof, and to avoid incompatibilities. In addition, during application and curing, they should escape from the coating in a manner tailored to the crosslinking reaction in progress so as to afford a solvent-free coating of optimal appearance and free of defects such as popping or pinholes. Suitable solvents include in particular those used in two-component technology. Examples of organic solvents are aliphatic, cycloaliphatic, and aromatic hydrocarbons, alcohols, glycols, glycol ethers, ketones, and esters, for example solvent naphtha, xylene, methoxypropyl acetate, ethyl acetate, butyl acetate, dipropylene glycol dimethyl ether, butoxypropanol, butyl glycol, butyl diglycol, ethylene glycol, diethyl glycol, butanone, acetone, ethanol, propanol, n-butanol, isobutanol, methyl ethyl ketone or hexanone, and also mixtures of said solvents. When the NCO-reactive component of the composition is in the form of an aqueous dispersion, water is also suitable as solvent or diluent.

Preferably, the molar ratio of NCO groups in component I to NH groups in component G is 2:1 to 0.9:1, more preferably 1:1 to 1.3:1.

Preferably, the content of the polyaspartic-ester-containing component G in the coating composition B_{K} is ≥10% to ≤80% by weight, more preferably ≥20% to ≤60% by weight, most preferably ≥30% to ≤50% by weight, in each case based on the total weight of the coating composition B_{K}.

Where further components H reactive toward isocyanate groups are present in the coating composition B_{K}, the content thereof is preferably up to 50% by weight (≤50% by weight), more preferably ≥5% to ≤40% by weight, most preferably ≥10% to ≤30% by weight, in each case based on the total weight of the coating composition B_{K}.

Where auxiliaries and additives J are present in the coating composition B_{K}, the content thereof is preferably up to 50% by weight (≤50% by weight), more preferably ≥5% to ≤40% by weight, most preferably ≥2% to ≤30% by weight, in each case based on the total weight of the coating composition B_{K}.

The coating composition B_{K} of the invention is preferably not a foamable or foam-forming composition. The compositions are preferably not polymerizable by free radicals, especially not photopolymerizable, i.e. the compositions do not cure through free-radical processes, especially not through free-radical polymerization processes initiated by actinic radiation.

The coating composition B_{K} of the invention is produced by methods known per se in paint technology.

An isocyanate-reactive component (K_{R}) and an isocyanate-containing component (K_{H′}) are first produced separately by mixing the respective isocyanate-reactive components G and optionally H, and by mixing the respective polyisocyanate component I. The auxiliaries and additives J are preferably admixed with the isocyanate-reactive component K_{R′}. The components K_{R′} and K_{H′} thus produced are not mixed together until immediately before or during application. When mixing takes place before application, it should be noted that the reaction of the constituents commences immediately after mixing. The rate of the reaction varies according to the choice of components and additives. The processing time within which the composition must be applied is also known as the pot life and is defined as the time from mixing of the components until doubling of the flow time; depending on the choice of components, this is in the range from 1 minute to 24 hours, usually in the range from 10 minutes to 8 hours. The pot life is determined by methods known to those skilled in the art.

The mixing of the components belonging to the isocyanate-reactive component K_{R′}, and also the mixing of the components belonging to the isocyanate-reactive component K_{H′}, can be carried out in tandem with or followed by dispersion.

The mixing of the components belonging to the isocyanate-reactive component K_{R′} and of the components belonging to the isocyanate-reactive component K_{H′} and the mixing of components K_{R′} and K_{H′} can be carried out using a stirrer system for example.

The invention also further relates to a layer system comprising a substrate, at least one partially cured or fully cured coating composition for a pigmented coating (B_{P}) according to the above description that is applied to at least part of the substrate and at least one coating composition for a clearcoat (B_{K}) according to the above description that is applied thereon.

The invention further relates to a process for producing a layer structure on a substrate, comprising at least the following steps:
i) applying at least one above-described coating composition for a pigmented coating (B_{P}) to at least part of a substrate to be coated,
ii) applying at least one above-described coating composition for a clearcoat (B_{K}) to at least part of the layer present on the substrate or layer structure present on the substrate from i), and
iii) completely curing the layer structure present on the substrate from ii).

The invention also provides a layer structure on a substrate obtainable by the process described above.

The coating compositions may be applied by customary application methods. Examples of application methods are brushing, roller application, knife application, dipping and spraying, with preference given to spray application.

The curing of the layer structure can take place in one step, i.e. after applying the uppermost layer of the clearcoat to be applied.

However, it is also possible even beforehand, after any earlier step of applying a layer, to carry out a curing step that results in incomplete or complete curing of the layers already present on the substrate.

The curing step(s) may be preceded by a flash-off step. The curing is carried out according to methods that are customary in coating technology, either under ambient conditions with regard to temperature and atmospheric humidity or under forced conditions, for example by raising the oven temperature, using radiation such as infrared, near-infrared or microwave radiation, and using dehumidified and/or heated air or other gases. This is preferably done without using devices for forced curing. Curing temperatures are from −20 to 100° C., preferably from −10 to 80° C., more preferably from 0 to 60° C., and most preferably from 10 to 40° C. Although not preferred, lower curing temperatures may likewise be employed, but will result in longer curing times. It is likewise possible, although not preferred, to cure the composition at higher temperatures, for example 80 to 160° C. or higher.

The terms “fully cured” or “cured” are to be understood in accordance with the invention as meaning that all crosslinkable groups present in the coating compositions, i.e. NCO groups and NCO-reactive groups, have undergone completely crosslinking, i.e. reacted. Although this crosslinking can occur solely between the NCO groups present in the coating composition and NCO-reactive groups, a crosslinking reaction of NCO groups with atmospheric moisture from the environment to form a urea group is for example also possible.

The terms “partially cured” or “incompletely cured” are therefore to be understood as meaning incomplete crosslinking of the crosslinkable groups present.

Particularly suitable substrates are metal substrates such as steel, iron- or alkaline-phosphate treated steel, zinc, and aluminum.

The coating systems of the invention are used in the coating of e.g. municipal utility vehicles, tractors, excavators, combines, cranes, forklifts, trucks, buses, trains, wagons, truck trailers, mobile cranes, of motor vehicle components (for example rims, windscreen wipers, trim strips), metal industrial goods, aircraft, work machines (for example blowers, pumps, compressors, haulers, harvesters) or machine tools (for example lathes, milling machines, drills, planers, and grinding machines).

### EXPERIMENTAL

All percentages are based on weight unless otherwise stated.

Products used:
Desmophen® NH 1423 LF (polyaspartic polyol), Covestro Deutschland AG, Leverkusen, Germany
Sylosiv® A4 (water scavenger), W.R. Grace & Co., Columbia, Maryland USA.
Methoxypropyl acetate, Carl Roth GmbH+Co KG, Karlsruhe, Germany
Butyl acetate, Carl Roth GmbH+Co KG, Karlsruhe, Germany
BYK® A 530 (defoamer), BYK-Chemie GmbH, Wesel, Germany
Disperbyk® 163 (dispersing additive), BYK-Chemie GmbH, Wesel, Germany
BYK® 331 (leveling additive), BYK-Chemie GmbH, Wesel, Germany
Heucophos® ZPA (anticorrosion pigment), Heubach GmbH, Langelsheim, Germany
Heucophos® ZPO (anticorrosion pigment), Heubach GmbH, Langelsheim, Germany
Baryte EWO (barium sulfate filler), Sachtleben Minerals GmbH & Co. KG, Hausach, Germany
Luzenac® 20M2 (talc filler), Imerys Minerals GmbH, Rheinberg, Germany
Tronox® RKB-4 (titanium dioxide pigment), Tronox, Stamford, USA
Bayferrox® 420 (yellow iron oxide pigment), Lanxess, Cologne, Germany
Asconium® 142 DA (corrosion inhibitor), Ascotec, Saint-Etienne, France
Tinuvin® 292 (HALS light stabilizer), BASF AG, Ludwigshafen, Germany
Tinuvin® 384-2 (UV light stabilizer), BASF AG, Ludwigshafen, Germany
Additives OF (water scavenger), Borchers GmbH, Langenfeld, Germany
Desmodur® ultra N 3600 (polyisocyanate), Covestro Deutschland AG, Leverkusen, Germany
Desmodur® 2873 (silane-modified polyisocyanate), Covestro Deutschland AG, Leverkusen, Germany

### Examples 1 and 2: Production of Primers 1a/1b and 2a/2b

TABLE 1

| | Primer formulation yellow | | |
|---|---|---|---|
| | Example | 1a/1b | 2a/2b |
| | Component I | | |
| 1 | Desmophen ® NH 1423 LF (polyaspartic polyol) | 27 | 23 |
| 2 | Sylosiv ® A4 (water scavenger) | 3 | 2.9 |
| 3 | Methoxypropyl acetate:butyl acetate (1:1) (solvent) | 7.4 | 6 |
| 4 | BYK ® A 530 (defoamer) | 0.4 | 0.4 |
| 5 | Disperbyk ® 163 (dispersing additive) | 2 | 2 |
| 6 | Heucophos ® ZPA (anticorrosion pigment) | 6.6 | 6.6 |
| 7 | Heucophos ® ZPO (anticorrosion pigment) | 6.6 | 6.6 |
| 8 | Baryte EWO (barium sulfate filler) | 3 | 3 |
| 9 | Luzenac ® 20M2 (talc filler) | 3 | 3 |
| 10 | Tronox ® RKB-4 (titanium dioxide pigment) | 3.8 | 3.8 |
| 11 | Bayferrox ® 420 (yellow iron oxide pigment) | 8 | 8 |
| 12 | Asconium ® 142 DA (corrosion inhibitor) | 1.9 | 1.9 |
| 13 | BYK ® 331 (10% in methoxypropyl acetate) | 0.4 | 0.4 |
| | (leveling additive) | | |
| 14 | Tinuvin ® 292 (50% in methoxypropyl acetate) | 2.4 | 2.4 |
| | (HALS light stabilizer) | | |
| | Subtotal for component I | 75.5 | 70 |
| | Component II | | |
| 15 | Desmodur ® ultra N 3600 (80% in methoxypropyl | 24.5 | |
| | acetate:butyl acetate (1:1)) (polyisocyanate) | | |
| 16 | Desmodur ® ultra N 3600:Desmodur ® 2873, 1:1 | | 30 |
| | (polyisocy anate:silane-modified polyisocyanate) | | |
| | 80% in methoxypropyl acetate:butyl acetate (1:1) | | |
| | Total | 100 | 100 |
| | NCO:NH ratio 1.1:1 | | |

To produce primer component I, constituents 1 to 14 are initially charged in a metal can with stirring. Glass beads are added for grinding and the mixture is ground using a Dispermat (stiffer), with cooling, for 45 minutes and then sieved. The prepared ground mixture (component 1) needs to rest for at least 24 hours. To produce the curing agent solution (component 11), the constituents from 15 or from 16 are mixed at 2000 rpm for 5 minutes and blended by stirring. Components I and II are incorporated by stirring at 2000 rpm for 1 minute using a stirrer. The NCO:NH ratio is 1.1:1. The primers 1a/1b and 2a/2b are then applied by spraying (Satjet spray gun, 2 bar 1.2 mm nozzle) at 23° C. and 50-60% relative humidity, in each case in two different layer thicknesses.

### Example 3: Production of a Pigmented Topcoat

TABLE 2
Yellow topcoat formulation that was applied to primer 1a/1b

| | Example | 3 |
|---|---|---|
| | Component I | |
| 1 | Desmophen ® NH 1423 LF (polyaspartic polyol) | 29.3 |
| 2 | Sylosiv ® A4 (water scavenger) | 4.3 |
| 3 | Methoxypropyl acetate:butyl acetate | 8.9 |
| | (1:1) (solvent) | |
| 4 | BYK ® A 530 (defoamer) | 0.4 |
| 5 | Disperbyk ® 163 (dispersing additive) | 2.2 |
| 6 | Baryte EWO (barium sulfate filler) | 4.5 |
| 7 | Luzenac ® 20M2 (talc filler) | 3.2 |
| 8 | Tronox ® RKB-4 (titanium dioxide pigment) | 9.6 |
| 9 | Bayferrox ® 420 (yellow iron oxide pigment) | 8 |
| 10 | BYK ® 331 (10% in methoxypropyl acetate) | 0.5 |
| | (leveling additive) | |
| 11 | Tinuvin ® 292 (50% in methoxypropyl acetate) | 2.5 |
| | (HALS light stabilizer) | |
| | Subtotal for component I | 73.4 |
| | Component II | |
| 12 | Desmodur ® ultra N 3600 (80% in methoxypropyl | 26.6 |
| | acetate:butyl acetate (1:1) (polyisocyanate) | |
| | Total | 100 |
| | NCO:NH ratio 1.1:1 | |

To produce topcoat component I, constituents 1 to 11 are initially charged in a metal can with stirring. Glass beads are added for grinding and the mixture is ground using a Dispermat (stiffer), with cooling, for 45 minutes and then sieved. The prepared ground mixture (component 1) needs to rest for at least 24 hours. To produce the curing agent solution (component 11), the constituents from 12 are mixed at 2000 rpm for 5 minutes and blended by stirring. Components I and II are blended by stirring at 2000 rpm for 1 minute using a stirrer. The NCO:NH ratio is 1.1:1.

### Example 4: Production of a Clearcoat

TABLE 3
Clearcoat formulation that was applied to primer formulation 2a/2b

| | Example | 4 |
|---|---|---|
| | Component I | |
| 1 | Desmophen ® NH 1423 LF | 44.5 |
| | (polyaspartic polyol) | |
| 2 | BYK ® 331 (10% in butyl acetate) | 0.1 |
| | leveling additive | |
| 2 | Additives OF (water scavenger) | 3 |
| 4 | Butyl acetate (solvent) | 9.4 |
| | Subtotal for component I | 57 |
| | Component II | |
| 5 | Desmodur ® ultra N 3600 | 32.7 |
| | (polyisocyanate) | |
| 6 | Methoxypropyl acetate:butyl acetate | 8.2 |
| | (1:1) (solvent) | |
| 7 | Tinuvin ® 292 (50% in butyl acetate) | 0.8 |
| | HALS light stabilizer | |
| 8 | Tinuvin ® 384 (50% in butyl acetate) | 1.3 |
| | UV light stabilizer | |
| | Subtotal for component II | 43 |
| | Total | 100 |
| | NCO:NH ratio 1.1:1 | |

To produce clearcoat component I, constituents 1 to 4 are initially charged in a metal can with stirring and mixed at 2000 rpm for 5 minutes. To produce the curing agent solution (component II), constituents 5-8 are mixed at 2000 rpm for 5 minutes and blended by stirring. Components I and II are blended by stirring at 2000 rpm for 1 minute using a stirrer. The NCO:NH ratio is 1.1:1.

After applying the two primers to degreased substrates (Q-Panel type R 48 steel sheet, alkali-phosphate-treated Gardobond® A 4976/D 6800/OC steel sheet, and aluminum), the pigmented topcoat or clearcoat described above is applied to each substrate after approx. 15 minutes and dried at room temperature (23° C.). Two total dry layer thicknesses (variant a=approx. 80 μm and b=approx. 140-150 μm) were tested in each case. The test results of the multilayer structures are shown in Table 4.

### Properties of Multilayer Structures:

TABLE 4

| | | | | |
|---|---|---|---|---|
| Example | 5a | 5b | 6a | 6b |

Application conditions 55% humidity, 23° C.
Structure

| Primer | | | Example | Example | Example | Example |
|---|---|---|---|---|---|---|
| | | | 1a | 1b | 2a | 2b |
| Topcoat (TC) | | | Example 3 | | — | |
| Clearcoat (CC) | | | — | | Example 4 | |
| Total dry layer thickness variants | | | a | B | a | b |
| Glass plate total layer thickness (μm) | | 1 d/7 d | 80 | 148 | 79 | 145 |
| primer + CC (TC) (μm) | | | 120/144 | 119/138 | 87/134 | 43/64 |
| Pendulum hardness of glass plate (s) | | | | | | |
| | | 14 d/21 d | 143/143 | 134/138 | 127/148 | 50/72 |
| | | 30 d/60 d | 145/151 | 137/142 | 148/167 | 76/137 |
| | | 90 d | 152 | 144 | 167 | 141 |
| Layer thickness on Q-Panel type R48, | | | 46 | 120 | 40 | 99 |
| primer only (μm) | | | | | | |
| Layer thickness on Q-Panel type R48, | | | 82 | 150 | 80 | 140 |
| primer + CC (TC) (μm) | | | | | | |
| Structure | Example | | 5a | 5b | 6a | 6b |
| Primer | | | Example | Example | Example | Example |
| | | | 1a | 1b | 2a | 2b |
| Topcoat (TC) | | | Example | Example | | |
| | | | 3 | 3 | | |
| Clearcoat (CC) | | | | | Example | Example |
| | | | | | 4 | 4 |
| Gloss 20°/60°/haze | | immedi- | 88/95/22 | 88/96/22 | 89/96/12 | 89/96/14 |
| primer + CC (TC) | | ately | | | | |
| | | 30 d | 88/95/22 | 88/96/22 | 89/96/12 | 89/96/14 |
| Adhesion | | | | | | |
| Q-Panel type R 48 | | 1 d/7 d | 5/5 | 5/5 | 1/0 | 0/0 |
| (steel) | | | | | | |
| | | 14 d/21 d | 5/5 | 5/5 | 1/2 | 0/0 |
| | | 30 d/60 d | 5/5 | 5/5 | 1/2 | 0/0 |
| | | 90 d | 5 | 5 | 0 | 0 |
| Aluminum | | 7 d | 5 | 5 | 0 | 0 |
| | | 60 d | 5 | 5 | 0 | 0 |
| | | 90 d | 5 | 5 | 0 | 0 |
| Water resistance | Gardobond alkaline- | | | | | |
| after 10 d exposure | phosphate-treated steel | | | | | |
| Gloss 20°/60°/haze | | | 76/91/120 | 78/93/140 | 86/95/20 | 86/95/28 |
| Blister formation | DIN EN ISO | immedi- | 3/2 | 3/2-3 | OK | OK |
| (size/number) | 4628-2 | ately | | | No | No |
| | | | | | blistering | blistering |
| Adhesion (cross-cut) | | immedi- | 5 | 5 | 0 | 0 |
| | | ately/ | | | | |
| | | after 24 h | | | | |
| Water resistance | Gardobond alkaline- | | | | | |
| after 20 d exposure | phosphate-treated steel | | | | | |
| Blister formation | | immedia- | 3/3//3/3 | 5/2-3//4/2-3 | OK | OK |
| (size/number) DIN | | tely/ | | | No | No |
| EN ISO 4628-2 | | after 24 h | | | blistering | blistering |
| Adhesion (cross-cut) | | after 1 h | 5/5 | 5/5 | 0 | 0 |
| | | after 24 h | | | | |
| Condensation water | Gardobond alkaline- | | | | | |
| test DIN EN ISO | phosphate-treated steel | | | | | |
| 6270-2 CH after 10 d | | | | | | |
| Blister formation 1 h | | | 5/3 | 5/3 | 2-3/3 | 2-3/3 |
| after end of test | | | | | | |
| Blister formation | | | 5/3 | 5/3 | 2-3/3 | 2-3/3 |
| 24 h after end of test | | | | | | |
| Adhesion 1 h after | | | 5 | 5 | 0 | 0 |
| end of test | | | | | | |
| Adhesion 24 h after | | | 5 | 5 | 0 | 0 |
| end of test | | | | | | |
| | Gardobond alkaline-phosphate-treated steel | | | | | |
| Salt spray test after 10 d | | Gardobond 2 mm | | | | |
| (DIN EN ISO 9227) | | scratch | | | | |
| Delamination at | | | 23 | >45 | 10 | 10 |
| scratch (mm) | | | | | | |
| Minimum (mm) | | | 22 | — | 8 | 6 |
| Maximum (mm) | | | 25 | — | 11 | 12 |
| Adhesion 1 h after | | | 5 | 5 | 0 | 0 |
| end of test | | | | | | |
| Adhesion 24 h after | | | 5 | 5 | 0 | 0 |
| end of test | | | | | | |
| Salt spray test after 20 d | | Gardobond 1 mm | | | | |
| (DIN EN ISO 9227) | | scratch | | | | |
| Delamination at | | | 26 | 28 | 14 | 9 |
| scratch (mm) | | | | | | |
| Minimum (mm) | | | 22 | 15 | 10 | 6 |
| Maximum (mm) | | | 40 | 40 | 16 | 11 |
| Adhesion 1 h after | | | 5 | 5 | 0 | 0 |
| end of test | | | | | | |
| Adhesion 24 h after | | | 5 | 5 | 0 | 0 |
| end of test | | | | | | |
| Salt spray test after 20 d | | Gardobond 2 mm | | | | |
| (DIN EN ISO 9227) | | scratch | | | | |
| Delamination at | | | 22 | >45 | 10 | 15 |
| scratch (mm) | | | | | | |
| Minimum (mm) | | | 15 | — | 5 | 10 |
| Maximum (mm) | | | 42 | — | 16 | 17 |
| Adhesion 1 h after | | | 5 | 5 | 0 | 0 |
| end of test | | | | | | |
| Adhesion 24 h after | | | 5 | 5 | 0 | 0 |
| end of test | | | | | | |
| Accelerated | | | | | | |
| weathering | | | | | | |
| UV-B test | Gloss 20°/60° | Start | 87/92 | 88/93 | 88/93 | 88/92 |
| According to DIN | | 500 h | 49/82 | 51/84 | 87/94 | 89/94 |
| EN ISO 16474/3, | | | | | | |
| Method C, Cycle 4 | | | | | | |
| | | 1000 h | 29/71 | 35/74 | 87/94 | 89/94 |
| UV-A test | Gloss 20°/60° | Start | 87/93 | 88/93 | 88/93 | 86/91 |
| According to DIN | | 1000 h | 46/81 | 49/82 | 88/94 | 88/94 |
| EN ISO 16474/3, | | | | | | |
| Method A, Cycle 1 | | | | | | |
| Accelerated | Gloss 20°/60° | Start | 87/92 | 89/93 | 87/92 | 89/93 |
| weathering | | | | | | |
| (xenon arc lamp) | | | | | | |
| According to DIN | | 1000 h | 37/76 | 39/78 | 89/94 | 90/94 |
| EN ISO 16474/2, | | | | | | |
| Method A, Cycle 1 | | | | | | |

The following tests were performed:
Determination of pendulum hardness (pendulum damping test) according to DIN EN ISO 1522.
Determination of cross-cut adhesion according to DIN EN ISO 2409 (cross-cut test), Cross-cut parameters: The GTO-GTS classification describes the damage pattern and represents a percentage range of the chipped coating area.
Water resistance was determined by immersing the test sheets in tap water at room temperature (23° C.) and performing corresponding tests after 10 days/20 days of exposure.
Condensation water test according to DIN EN ISO 6270-2 CH.
Salt spray test according to DIN EN ISO 9227.
Determination of blister formation (size/number) according to DIN EN ISO 4628-2.
Accelerated weathering according to DIN EN ISO 16474/3. Method C, Cycle 4, according to DIN EN ISO 16474/3. Method A, Cycle 1, and according to DIN EN ISO 16474/2, Method A, Cycle 1.
Determination of gloss value according to DIN EN ISO 2813.

For determination of the dry layer thickness of coatings on metallic substrates, two methods were chosen: for the measurement on magnetic substrates (iron) the magnetic method according to DIN EN ISO 2178 was used, and for the measurement on non-magnetic substrates (for example aluminum) the eddy current method according to DIN EN ISO 2360 was used

The dry layer thickness on glass was determined with a depth gauge according to DIN EN ISO 2808.

From the values in Table 4 it can be seen that the multilayer structure based on the inventive multilayer structure of examples 6a and 6b (consisting of primer 2a/2b and the respective clearcoat 4) for both selected total dry layer thicknesses (variant a=approx. 80 μm and b=approx. 140-150 μm) is markedly superior to the noninventive multilayer structure of examples Sa and Sb (consisting of primer 1a/1b and the respective topcoat 3), with very good hardness, comparable initial gloss, in adhesion when stored exclusively at room temperature, in adhesion and blister formation when stored in water, in adhesion and blister formation in the condensation water test, in adhesion and rust infiltration in the salt spray test, and in gloss retention in accelerated weathering.

1. A layer structure comprising at least one partially cured or fully cured coating composition for a pigmented coating (B_{P}) and at least one coating composition for a clearcoat (B_{K}) applied thereon,
where
i) the at least one coating composition B_{P} comprises the following components:
A) at least one polyaspartic-ester-containing component, comprising
A1) one or more polyaspartic esters of the general formula (I) 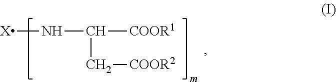
in which
X is an m-valent organic radical, optionally containing one or more heteroatoms, as can be obtained by removing the primary amino groups from a corresponding polyamine that has (cyclo)aliphatically or araliphatically attached primary amino groups and is in the molecular weight range from ≥60 to ≤6000 g/mol and that may contain further functional groups reactive toward isocyanate groups or functional groups inert at temperatures of up to 100° C.,
R¹ and R² are identical or different organic radicals each having 1 to 18 carbon atoms,
m is an integer ≥1,
and
A2) optionally one or more polyaspartic esters having a primary amino group that are of the general formula (II) 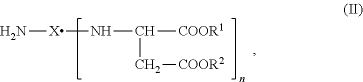
in which
n is m −1,
X and the radicals R¹ and R² are as defined above,
and
A3) optionally one or more dialkyl fumarates,
B) optionally at least one component reactive toward isocyanate groups that is different from A,
C) at least one silane-functional polyisocyanate containing at least one silane group of the general formula (III) 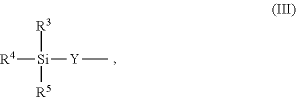
in which
R³, R⁴, and R⁵ are identical or different radicals and are each a saturated or unsaturated, linear or branched, aliphatic or cycloaliphatic radical or optionally substituted aromatic or araliphatic radical having up to 18 carbon atoms, which may optionally contain up to 3 heteroatoms from the group of oxygen, sulfur, and nitrogen, and
Y is a linear or branched organic radical having at least 2 carbon atoms that may optionally contain up to 2 imino groups (—NH—),
D) optionally at least one polyisocyanate different from C,
E) at least one pigment,
F) optionally further auxiliaries and additives,
and
ii) the at least one coating composition B_{K} comprises the following components:
G) at least one polyaspartic-ester-containing component, comprising
G1)one or more polyaspartic esters of the general formula (IV) 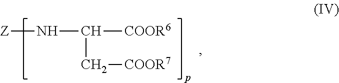
in which
X is a p-valent organic radical, optionally containing one or more heteroatoms, as can be obtained by removing the primary amino groups from a corresponding polyamine that has (cyclo)aliphatically or araliphatically attached primary amino groups and is in the molecular weight range from ≥60 to ≤6000 g/mol and that may contain further functional groups reactive toward isocyanate groups and/or functional groups inert at temperatures of up to 100° C.,
R⁶ and R⁷ are identical or different organic radicals each having 1 to 18 carbon atoms,
p is an integer ≥1,
and
G2)optionally one or more polyaspartic esters having a primary amino group that are of the general formula (V) 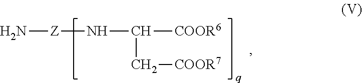
in which
q is p−1,
Z and the radicals R⁶ and R⁷ are as defined above,
and
G3)optionally one or more dialkyl fumarates,
H) optionally at least one component reactive toward isocyanate groups that is different from G,
I) at least one polyisocyanate,
J) optionally auxiliaries and additives.

2. The layer structure of claim 1, wherein silane-functional polyisocyanates (C) are used that are a reaction product of:
(C1) at least one polyisocyanate and
(C2₁) at least one compound reactive toward isocyanate groups of the general formula (IX) 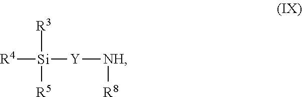
in which
R³, R⁴, R⁵, and Y are as defined for formula (III) and
R^{a} is i) hydrogen, a saturated or unsaturated, linear or branched, aliphatic or cycloaliphatic radical or an optionally substituted aromatic or araliphatic radical having up to 18 carbon atoms, or|

ii) a radical of the formula 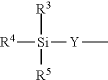
in which R³, R⁴, R⁵, and Y are as defined for formula (III), or|

iii) a radical of the formula 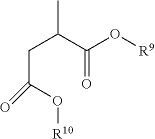
in which R⁹ and R¹⁰ are independently saturated or unsaturated, linear or branched, aliphatic or cycloaliphatic or aromatic organic radicals having 1 to 18 carbon atoms that may be substituted or unsubstituted and/or have heteroatoms in the chain, or
iv) a radical of the formula 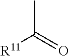
in which R¹¹ is hydrogen or a saturated linear or branched, aliphatic or cycloaliphatic organic radical having 1 to 8 carbon atoms.

3. The layer structure of claim 1, wherein the weight ratio of component C to component D is 2:98 to 1:0, preferably 1:1.

4. The layer structure as claim 1, wherein the content of pigments E in the coating composition B_{P} is ≥0.1% to ≤50% by weight, based on the total weight of the coating composition B_{P}.

5. (canceled)

6. A process for producing the layer structure of claim 1 on a substrate, comprising at least the following steps:
i) applying at least one coating composition for the pigmented coating (B_{P}) of claim 1 to at least part of the substrate,
ii) applying at least one coating composition for the clearcoat (B_{K}) of claim 1 to at least part of the layer present on the substrate from i), and
iii) curing the layer structure present on the substrate from ii).

7. The process of claim 6, wherein the curing step iii) is preceded by at least one further curing step that takes place between the application of two successive layers and results in incomplete or complete curing of the layers present on the substrate at the time of this curing step.

8. The process of claim 6, wherein the curing step iii) is preceded by an flash-off step.

9. The process of claim 6, wherein the curing step iii) takes place at a temperature ranging from −20 to 160° C.

10. (canceled)

11. The process as claim 6, wherein the substrate is metallic, steel, iron- or alkaline-phosphate treated steel, zinc or aluminum.

12. (canceled)

13. The process of claim 6, wherein the curing step iii) takes place at a temperature ranging from −20 to 100° C.

14. The process of claim 6, wherein the curing step iii) takes place at a temperature ranging from −10 to 80° C.

15. The process of claim 6, wherein the curing step iii) takes place at a temperature ranging from 0 to 60° C.

16. The layer structure of claim 1, wherein silane-functional polyisocyanates (C) are used that are a reaction product of:
(C1) at least one polyisocyanate and
(C2₁) at least one compound reactive toward isocyanate groups of the general formula (X) 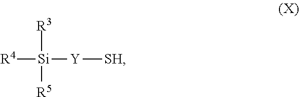
in which R³, R⁴, and R⁵ are as defined for formula (III) and
Y is a linear or branched organic radical having at least 2 carbon atoms.

17. The layer structure of claim 1, wherein silane-functional polyisocyanates (C) are used that are a reaction product of:
(C1) at least one polyisocyanate and
(C2₂) at least one hydroxyurethane and/or hydroxyamide containing silane groups obtainable from the reaction of aminosilanes with cyclic carbonates or lactones.

18. The layer structure of claim 1, wherein the content of pigments E in the coating composition B_{P} is ≥5% to ≤40% by weight, based on the total weight of the coating composition B_{P}.

19. The layer structure of claim 1, wherein the content of pigments E in the coating composition B_{P} is ≥10% to ≤30% by weight, based on the total weight of the coating composition B_{P}.
